(19) United States
(12) Patent Application Publication
(10) Pub. No.: US 2019/0252689 A1
(43) Pub. Date: Aug. 15, 2019

(54) PREFORMATION OF SOLID ELECTROLYTE INTERPHASE ON ELECTRODES FOR RECHARGEABLE LITHIUM METAL BATTERIES

(71) Applicant: Battelle Memorial Institute, Richland, WA (US)

(72) Inventors: Wu Xu, Richland, WA (US); Bin Liu, Richland, WA (US); Ji-Guang Zhang, Richland, WA (US)

(73) Assignee: Battelle Memorial Institute, Richland, WA (US)

(21) Appl. No.: 16/337,812

(22) PCT Filed: Oct. 11, 2017
(86) PCT No.: PCT/US2017/056081

§ 371 Date: Mar. 28, 2019

Related U.S. Application Data
(60) Provisional application No. 62/406,761, filed on Oct. 11, 2016.
(60) Provisional application No. 62/486,303, filed on Apr. 17, 2017.

(51) Int. Cl. H01M 4/88; H01M 12/08; H01M 4/96; H01M 4/38

(52) U.S. Cl. CPC H01M 4/8878; H01M 4/382; H01M 4/96; H01M 12/08

(57) ABSTRACT

A one-step in-situ electrochemical pre-charging strategy to generate thin protective films simultaneously on the surfaces of both carbon-based air-electrode and metal anode under an inert atmosphere is disclosed. The thin-films are formed from the decomposition of electrolyte during the in-situ electrochemical pre-charging process in an inert environment and can protect both a carbon air-electrode and a metal anode prior to conventional metal-oxygen discharge/charge cycling where reactive reduced oxygen species are formed. Lithium-oxygen cells after such pre-treatment demonstrate significantly extended cycle life which is far more than those without pre-treatment.

### CROSS-REFERENCE TO RELATED APPLICATIONS

This claims the benefit of the earlier filing date of U.S. Provisional Application No. 62/406,761, filed Oct. 11, 2016, and U.S. Provisional Application No. 62/486,303, filed Apr. 17, 2017, each of which is incorporated in its entirety herein by reference.

### ACKNOWLEDGMENT OF GOVERNMENT SUPPORT

This invention was made with government support under Contract DE-AC0576RL01830 awarded by The U.S. Department of Energy. The government has certain rights in the invention.

### FIELD

Disclosed are pretreatment processes for in-situ formation of solid electrolyte interphase (SEI) films on electrodes for metal-air or metal-oxygen batteries.

### BACKGROUND

Rechargeable nonaqueous metal-air (and metal-oxygen) batteries with their extremely high theoretical specific energy have attracted much interest for energy storage systems, especially for use in electrical vehicles. However, the complex chemistries of the metal-air battery system cause several issues regarding the instability of their carbon-based air electrodes, metal anodes and electrolytes. For example, carbon-based air-electrodes and lithium (Li) metal anodes react with reduced oxygen species, especially superoxide radical anion (O₂^{-•}), and thus, need to be improved.

### SUMMARY

We disclose one-step, in-situ electrochemical processes to make preformed, thin protective films (also referred to herein as solid electrolyte interphase (SEI) films) on electrodes for use in metal-air (or metal-oxygen) batteries, such as in lithium-air (Li-air), lithium-oxygen (Li—O₂), sodium-air and potassium-air battery systems. Certain embodiments include preforming SEI films on carbon nanotubes (CNTs) used as an air-electrode surface (the cathode). In other embodiments the cathode may comprise any suitable, highly porous, high surface area material, such as a graphene material, a carbon fiber, a CNTs/graphene composite material, graphite, and the like. In certain embodiments Li metal is utilized as an anode. In certain embodiments, the cathode and/or anode are placed in the electrolyte, in an inert atmosphere, and pretreated to make preformed SEI films thereon. Li-air (or Li—O₂) cells or other suitable battery systems, after the disclosed pretreatment processes, demonstrate greatly enhanced cycling stability when compared to the cells without pre-treatment.

In one embodiment, a method for pretreating metal-air battery electrodes includes exposing at least one electrode for a metal-air battery to a metal-air battery electrolyte in an inert atmosphere. In an independent embodiment, a method for pretreating metal-air battery electrodes includes exposing a metal-air battery cathode and a lithium, sodium, potassium, magnesium, aluminum, iron, or zinc anode, simultaneously, to a metal-air battery electrolyte in an inert atmosphere. In another independent embodiment, a method for pretreating metal-air battery electrodes includes exposing a carbon-based cathode and a lithium metal anode to a lithium-air battery electrolyte in an inert atmosphere. In yet another independent embodiment, a method for pretreating metal-air battery electrodes includes exposing a carbon-based material or carbon-based material/catalyst composite cathode and a lithium (or sodium, potassium) metal anode simultaneously to a metal-air battery electrolyte in an inert atmosphere. In still another independent embodiment, a method for pretreating metal-air battery electrodes includes exposing a carbon nanotubes (CNTs)-material or CNTs-material/RuO₂composite cathode and a lithium, sodium, or potassium metal anode simultaneously to a metal-air battery electrolyte in an inert atmosphere.

In one embodiment, the at least one electrode for a metal-air battery is a carbon based cathode or a carbon material or catalyst composite cathode. In another embodiment, the at least one electrode for a metal-air battery is a lithium, sodium or potassium metal anode.

In any or all of the above embodiments, the at least one electrode for a metal-air battery may be charged with an areal current density from 0.01 mA cm⁻² to 5 mA cm⁻², or an areal current density from 0.05 mA cm⁻² to 2 mA cm⁻², or an areal current density from 0.1 mA cm⁻² to 0.5 mA cm⁻². In any or all of the above embodiments, the at least one electrode for a metal-air battery may be charged to 5 V or 4.2 V. In any or all of the above embodiments, the at least one electrode for a metal-air battery may be charged for a time period of from 1 second to 1 hour, or a time period of from 30 seconds to 30 minutes, or a time period of from 1 minutes to 15 minutes, or for 10 minutes.

In any or all of the above embodiments, the inert atmosphere may be argon, nitrogen, helium, or neon gas. In any or all of the above embodiments, the electrolyte may be lithium trifluoromethanesulfanate, or sodium trifluoromethanesulfanate, or potassium trifluoromethanesulfanate.

In some embodiments, a method for pretreating metal-air battery electrodes includes exposing a CNTs-material cathode and a lithium, sodium, or potassium metal anode to a metal-air battery electrolyte in an atmosphere with less than 1 wt % of oxygen; and applying a constant voltage of 4.3 V to the CNTs-material cathode and the lithium, sodium, or potassium metal anode, simultaneously, for a time period of 10 minutes, while the cathode and anode are in the atmosphere with less than 1 wt % of oxygen.

### BRIEF DESCRIPTION OF THE DRAWINGS

FIG. 1(a) is a schematic illustration of an embodiment of the disclosed electrochemical pretreatment process of assembled Li metal coin cells in an argon (Ar) atmosphere to, in-situ, generate thin protective films on both a carbon electrode and a Li metal anode, and then the regular discharge/charge cycling in an air or O₂ atmosphere.

FIG. 1(b) is a schematic of the theorized operation mechanism or principle of embodiments of the disclosed preformed SEI films, as illustrated via an embodiment comprising a complete battery system's CNTs air-electrode and Li metal anode, showing the cells before and after the battery cells undergo in-situ, one-step electrochemical process in an inert atmosphere, followed by the regular discharge/charge cycling of the battery system in an air or O₂ atmosphere.

FIGS. 2(a)-(f) are electrochemical charging curves of certain embodiments of the disclosed Li∥CNTs coin cells with an electrolyte of 1 M lithium trifluoromethanesulfonate (LiTf) in tetraethylene glycol dimethyl ether (tetraglyme) at a current density of 0.1 mA cm⁻² from open circuit voltage (OCV) to (a-e) 4.3 V followed by holding at 4.3 V for different time periods under an Ar atmosphere: (a) 0 min, (b) 5 min, (c) 10 min, (d) 15 min, and (e) 20 min, and to (f) 4.5 V following by holding at 4.5 V for 0 min.

FIG. 3 shows a.c.-impedance spectra of CNTs electrodes before and after pretreatment (charged to 4.3 V followed by 10 min at 4.3 V).

FIGS. 4(a)-(g) are high-resolution transmission electron microscopy (HR-TEM) images of (a) pristine carbon nanotubes (CNTs), and certain embodiments of the disclosed (b) in-situ, pretreated CNTs with a charge applied at 0.1 mA cm⁻² to 4.3 V followed by constant voltage charging at 4.3 V for 0 min, (c) 5 min, (d) 10 min, (e) 15 min, (f) 20 min, and (g) pre-treated CNTs at 4.5V.

FIGS. 5(a)-(e) are (a-d) narrow scan XPS spectra of an embodiment of the pre-charging treated CNTs electrode surface and the pristine CNTs electrode surface for (a) F 1s, (b) O 1s, (c) S 2p, (d) C 1s, (e) the corresponding wide scan XPS spectra. This embodiment of the disclosed pretreatment process was held at 4.3 V for10 min.

FIGS. 6(a)-(d) are, (a-c) narrow scan XPS spectra of an embodiment of the pre-charging treated Li metal anode surface and the pristine Li metal surface for (a) F 1s, (b) O 1s, (c) S 2p, and (d) a corresponding wide scan XPS spectra. This embodiment of the pretreatment process was 4.3 V for 10 min.

FIGS. 7(a)-(g) are discharge/charge voltage profiles of embodiments of the disclosed Li—O₂ cells with a pristine CNTs air electrode (a) and pretreated CNTs air electrodes at 4.3 V for 0 min (b), 4.3 V for 5 min (c), 4.3 V for 10 min (d), 4.3 V for 15 min (e), and 4.3 V for 20 min (f). FIG. 7(h) compares the corresponding stable cycling life of different embodiments of the disclosed devices and a pristine device. The cell cycling was conducted under the 1000 mAh g⁻¹-carbon capacity limited protocol at 0.1 mA cm⁻² between 2.0 V and 4.5 V.

FIGS. 8(a)-(b) are a.c. impedance spectra of certain embodiments of the Li-02 cells with CNTs air electrodes after pretreatment at 4.3 V for 10 min after 110 regular charge/discharge cycles (a), and with pristine CNT air electrodes after 70 regular cycles (b).

FIGS. 9(a)-(f) are scanning electron microscope (SEM) surface-view images of certain embodiments of the disclosed CNTs air electrodes without pretreatment after 70 regular cycles (FIGS. 9(a) and (b)), the CNTs air electrodes with 4.3 V for 10 min pretreatment after 110 regular cycles (FIGS. 9(c) and (d)), and the pristine CNTs air electrodes (FIGS. 9(e) and (f)).

FIGS. 10(a)-(d) are SEM images of an untreated Li metal anode after 70 cycles (FIGS. 9(a) and 9(b)), and a certain embodiment of a pretreated Li metal anode after 110 cycles (FIGS. 9(c) and (d)), where FIGS. 9(a) and (c) are cross-section views and FIGS. 9(b) and (d) are top views.

FIG. 11 is an SEM image of a cross-section view of a pristine Li metal anode.

FIGS. 12(a) and (b) are voltage profiles and cycle life of certain embodiments of the disclosed in situ pretreated RuO₂/CNTs electrodes (4.3 V-10 min). FIGS. 12(c) and (d) are voltage profiles and cycle life of control RuO₂/CNTs electrodes without pretreatment, at a current density of 0.1 mA cm⁻², and an electrolyte comprising 1.0 M LiTf-tetraglyme.

FIGS. 13(a)-(d) are voltage profiles of certain embodiments of the disclosed RuO₂/CNTs electrodes first discharged to (a) 0.2 V, (b) 0.8 V, (c) 1.4 V and (d) 2.0 V, respectively and then recharged to 4.3 Vat 0.1 mA cm⁻². FIG. 13(e) shows a corresponding cycling performance of certain embodiments of the disclosed pretreated RuO₂/CNTs electrodes in Li—O₂ cells under 1000 mAh g⁻¹ at 0.1 mA cm⁻².

FIGS. 14(a)-(o) are a schematic diagram of the atomic force microscopy (AFM) setup connected with an electrochemical workstation (a); AFM images of a Li metal surface at OCP before charging (0 min (b), 8 min (c), and 16 min (d)); selected AFM images of a Li metal surface collected at different voltages upon cell charging (3.1 V (e), 3.4 V (f), 3.7 V (g), 4.0 V (h), 4.3 V (i), holding at 4.3 V for 5 min (j), 10 min (k), 15 min (l), and 20 min (m)); (n) the surface roughness of Li metal surface under open circuit potential (OCP) on basis of two different calculation methods (Rq and Ra) and (o) the change of surface roughness of films formed on Li metal surface upon cell charging at different states.

FIG. 15 are pre-charging curves of a three-electrode cell at a current density of 0.1 mA cm-2 clearly indicating voltage change of full cell (V_{WE-CE}), voltage change of CNTs air-electrode (V_{WE-RE}), and voltage change of Li metal anode (V_{CE-RE}). Within, CNTs air-electrode was used as working electrode, two Li metal electrodes were served as counter electrode (CE) and reference electrode (RE). 1 M LiTf-tetraglyme was used as electrolytes.

FIGS. 16(a)-(d) are SEM images of cycled RuO₂/CNTs air-electrode with an embodiment of the pretreatment process preformed SEI films (discharge: 0.8 V; charge: 4.3 V) (a), corresponding cycled Li metal anode (b), pristine RuO₂/CNTs air electrode surface (c) and pristine Li metal anode surface (d).

FIGS. 17(a)-(b) are, (a) voltage profiles of Li—O₂ cells based on RuO₂/CNTs electrodes with a pretreatment of first discharging to 0.8 V and then charging to 4.3 V paired with a lithium iron phosphate (LiFePO₄, LFP) anode cycled at 0.1 mA cm⁻² under a capacity protocol of 1,000 mAh g⁻¹, and (b) corresponding cycling performance of the cells.

### DETAILED DESCRIPTION

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable processes and materials are described below. The materials, processes, and examples are illustrative only and not intended to be limiting. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

Any of the above or below listed elements of the disclosed pretreatment processes (and/or preformed SEI composition components) may be used in any of various combinations to form an embodiment of the disclosed pretreatment processes and form the disclosed preformed SEI films on one or more electrodes. In addition, although alternatives are provided throughout this disclosure, such as a listing of possible inert gases, provision of such alternatives does not imply that the various alternatives are equivalent in performance, characteristics, or otherwise, nor that the various combinations of elements are necessarily equivalent.

To facilitate review of the various embodiments of the disclosure, the following explanations of specific terms are provided:

Anode: An electrode through which electric charge flows into a polarized electrical device. From an electrochemical point of view in a rechargeable battery, positively-charged cations move away from the anode during discharge to balance the electrons leaving via external circuitry. When the battery is recharged, the anode becomes the positive terminal where electrons flow in and metal cations are reduced. For purposes of this disclosure, the term “anode” refers to a solid anode, e.g., an alkali metal, carbon-based anode, or silicon anode and does not refer to components of the electrolyte.

Cathode: An electrode through which electric charge flows out of a polarized electrical device. From an electrochemical point of view in a rechargeable battery, positively charged cations move toward the cathode during discharge to balance the electrons arriving from external circuitry. When the battery is recharged, the cathode becomes the negative terminal where electrons flow out and metal atoms (or cations) are oxidized. As used herein, an air electrode is based on CNTs, graphene, carbon fibers, carbon cloth, carbon paper, nickel foam, metal oxides, metal carbides, noble metals (platinum, palladium, ruthenium, gold, silver, or any their mixtures).

Cell: As used herein, a cell refers to an electrochemical device used for generating a voltage or current from a chemical reaction, or the reverse in which a chemical reaction is induced by a current. Examples include voltaic cells, electrolytic cells, redox flow cells, and fuel cells, among others. Multiple single cells can form a cell assembly, often termed a stack. A battery includes one or more cells, or even one or more stacks.

CNT or carbon nanotube: As used herein a CNT is a tube-shaped material, made of carbon, having a diameter measuring on the nanometer scale. CNTs are unique because the bonding between the atoms is very strong and the tubes can have extreme aspect ratios. The CNTs used herein generally have walls formed by one-atom-thick sheets of carbon, known as graphene.

Coin cell: As used herein is a relatively small, typically circular-shaped, or button-like, battery. Coin cells are characterized by their diameter and thickness. For example, a type 2325 coin cell has a diameter of 23 mm and a height of 2.5 mm.

Electrolyte: As used herein, the term “electrolyte” refers to a non-aqueous solution of an alkali metal salt or a mixture of alkali metal salts dissolved in an organic solvent or a mixture of organic solvents.

Inert Atmosphere: As used herein inert atmosphere means a nonreactive gas atmosphere, and in particular embodiments means an atmosphere completely or substantially free of oxygen; “substantially free of oxygen” means less than 1 wt %, preferentially less than 100 ppm (part per million), more preferentially less than 1 ppm oxygen.

In Situ: As used herein “in situ” means when the anode and air cathode are positioned or formed in a complete battery or cell with the electrolyte that will be used for regular cycling, the battery or cell essentially or completely ready for use, but prior to any regular discharge/charge cycles for which the battery or cell is to be used. To be considered in situ, the electrolyte, cathode, and anode present must be the electrolyte, cathode, and anode that will be used for normal cycling of the battery to store/produce energy.

Metal-Air Battery: As used herein is a metal-air electrochemical cell or battery chemistry that uses oxidation of a metal at the anode and reduction of oxygen at the cathode to induce a current flow, and is an open system (meaning open to atmospheric air and using air gas source for cell or battery) when cells are discharged. As used herein a lithium-air (Li-Air) battery is a metal-air battery having lithium metal at the anode.

Metal-Oxygen Battery: As used herein is a metal-oxygen electrochemical cell or battery chemistry that uses oxidation of a metal at the anode and reduction of oxygen at the cathode to induce a current flow, and is an open system (meaning open to oxygen gas and using oxygen gas source for cell or battery) when cells are discharged. As used herein a lithium-oxygen (Li—O₂) battery is a metal-oxygen battery having lithium metal at the anode. The oxygen may be pure or substantially pure oxygen, or the oxygen may be provided by air. Thus, in some instances where oxygen is provided by air, the terms metal-air battery and metal-oxygen battery are interchangeable.

Lithium-anode: As used herein a “Li-anode” may comprise lithium metal, lithiated graphite, lithiated silicon, lithiated tin, lithiated metal oxides, and lithiated sulfides.

Lithium-metal anode: As used herein a “Li-metal anode” comprises substantially pure Li-metal with less than 0.1% of Li₂CO₃/LiOH/Li₂O or may comprise pure Li-metal. Other metal anodes can be used in the present invention, particularly if the process is used for other metal-air or in (metal-oxygen) systems, such as sodium-air and potassium-air battery systems.

Nonaqueous: Not including water, specifically including no more than trace amounts (<100 ppm) of water.

Preformed SEI: As used herein, a “preformed SEI” means an SEI film formed on the electrode during a pretreatment process, before the cell is cycled for the purpose of producing or storing energy. The only “cycling” of the cell, or battery system in which the cell is placed, performed during the preformed SEI formation process is the charging or discharging that may occur when the electrode is exposed to the electrolyte and/or a voltage is applied to the electrode to form the SEI. This preformation charge/discharge is not for the purpose of producing or storing energy and is performed prior to regular cycling (charge/discharge) in an air (or O₂) environment.

SEI: Solid electrolyte interphase or a thin protective film formed on an electrode (anode and/or cathode) surface.

Separator: A battery separator is a porous sheet or film placed between the anode and cathode to prevent physical contact between the anode and cathode while facilitating ionic transport.

As disclosed herein a typical metal-air battery or cell that may be a Li-air, Zn-air, Na-air, Mg-air, Al-air, Fe-air, or K-air battery or cell with which the disclosed pretreatment processes can be used, is an open system with respect to material flow, heat transfer, and work. For instance, the processes may be used with a metal-air battery or cell including openings, or vents, which mediate air transport between the metal-air battery and atmospheric air. In certain embodiments, moisture and interfering gases from the air are filtered, eliminated, or trapped prior to the air's being introduced to the metal-air battery. For instance, the disclosed processes may be used with a metal-air battery or cell having an air positive electrode electrically communicating with a metal negative electrode through an electrolyte and a separator. The air positive electrode, in certain configurations, includes a carbon composition positive electrode. During a normal cycling of such a system when a charge reaction takes place, oxygen is released to the ambient air.

As disclosed herein a typical embodiment of a metal-oxygen battery system that may be a Li-oxygen, Zn-oxygen, Na-oxygen, Mg-oxygen, Al-oxygen, Fe-oxygen, or K-oxygen battery or cell with which the presently disclosed processes may be used, includes an electrolyte, a cathode and an anode, and in some embodiments, a lithium metal material. The metal-oxygen battery system typically further includes an oxygen containment unit in communication with and external to the metal-oxygen battery. The oxygen containment unit includes an oxygen storage material. The metal-oxygen battery system may also include a reversible closed-loop in fluid communication with the metal-oxygen battery and the oxygen containment unit, which may be spaced apart from each other.

Carbon-based materials have been widely used for air electrodes in rechargeable metal-air batteries (such as lithium-air, sodium-air and potassium-air battery systems) due to their ideal and adjustable porous network architectures, high specific surface area, high pore volume, outstanding electrical conductivity, low cost, etc. The same is true for use of carbon-based materials in metal-oxygen batteries. However, there are challenges hindering the use of metal-air battery systems and metal-oxygen battery systems, such as instability of electrolytes against reactive, reduced oxygen species (O₂^{-•}, LiO₂, Li₂O₂, etc.) generated during the oxygen reduction reaction (ORR) process (during discharging), reactions of carbon material in air (or oxygen) electrodes with LiO₂ and Li₂O₂, oxidation of carbon at voltages above 3.5 V in the presence of O₂ and Li⁺, and high oxygen evolution reaction (OER) potential (during charging), which all metal-air or metal-oxygen battery systems undergo during cycling.

One way to address the instability of carbon-based oxygen electrodes is to use non-carbon materials including porous gold (Au), or nanosized titanium carbide (TiC) and boron carbide (B₄C), or transition metal nitrides, or transition metal oxides to replace carbon; however, practical application of these materials is not promising because of the high cost of Au, the instability of TiC due to the oxidation exposure to oxygen, the small surface area, and/or low electrical conductivity for metal carbides, metal nitrides and metal oxides. Another way to alleviate the instability of carbon-based air-electrode is to incorporate functional non-carbon catalysts (Ru, RuO₂, Au, Pt/Au, Pd, Pt, MnO₂, Co₃O₄, MnCo₂O₄, ZnCo₂O₄) with highly-conductive carbon materials to form catalysts/carbon composites, or add redox mediators into electrolytes, which may decrease charge over-potential during charging process and mitigate oxidation of carbon unless the charge voltage is less than 3.5 V. In fact, reduced oxygen species (especially superoxide radical anions) with extremely high reactivity will favor attack of the exposed carbon air-electrode, electrolyte, and Li metal anode. Therefore, it is very difficult to rely on catalysts/carbon composites or mediators to achieve significantly enhanced stability of rechargeable Li-air (or Li—O₂) batteries. To address some of the problems the carbon materials may be treated to form a protective layer before being placed in the completed battery or cell, or alternatively, by placing the electrode in the cell/battery having a different electrolyte than that used for cycling. This first electrolyte is used to form an SEI. The first electrolyte is then removed and the cell/battery is refilled with the charge/discharge electrolyte for operation to produce/store energy. However, these processes add extra steps, labor and equipment to carry out.

Disclosed herein are one-step, in-situ electrochemical processes to preform thin protective films (referred to herein as preformed SEI films) on either the cathode (such as a CNTs air-electrode) and/or Li anode (such as a Li-metal anode), prior to the batteries (or cells) being cycled (i.e., prior to the batteries or cells being discharged and/or charged) in an air (or O₂) atmosphere, but after the electrodes are placed in a complete battery or cell. As used herein a “complete battery or cell” means a battery or cell including an electrolyte, cathode, and anode, wherein the electrolyte, cathode, and anode of the complete battery or cell may be used for in-situ electrochemical processes and subsequent cycles of the batteries or cells. In other words, a continuous one-step process is performed by combining pre-treatment and cycling processes within the complete batteries or cells. Complete battery systems include the electrolyte that will be used for regular operation (charge and discharge) of the battery/cell—no change or addition of the electrolyte must take place before regular operation of the battery or cell. Embodiments of the disclosed process thus eliminate the need to first treat an electrode and then move the treated electrode into the battery or cell in which it will eventually operate to store and provide energy or the requirement to change electrolyte solutions. In certain embodiments the processes preform SEI films on the cathode and anode simultaneously, or essentially simultaneously.

Embodiments of the disclosed processes provide a one-step, in-situ electrochemical pretreatment process to generate preformed thin protective films on either (or both) the air electrode (e.g., formed at least in part of CNTs) and the metal anode (e.g., Li-metal anodes), in some embodiments simultaneously. The preformed SEI film is formed in an inert atmosphere, i.e., free of or substantially free of oxygen. In certain embodiments the metal-air or metal-oxygen cells or batteries (e.g., Li—O₂ cells) after such pretreatment demonstrate significantly extended stable cycle lives of 110 and 180 cycles, certain embodiments under capacity-limited protocols of 1000 mAh g⁻¹ or 500 mAh g⁻¹, respectively. By “stable cycles” in the capacity limited operations disclosed herein, we mean the battery can reach the desired discharge capacities (battery working capacities, such as 1000 mAh g⁻¹ or 500 mAh g⁻¹) in all of the cycles without exceeding the pre-determined charge/discharge voltage (such as 2 to 4.5V). This is far more cycles than those cells without pretreated electrodes. The preformed SEIs are formed from decomposition of electrolyte during embodiments of the disclosed in-situ electrochemical pretreatment process in an inert environment. In certain embodiments the disclosed processes provide preformed SEI films on both electrodes thereby protecting both the air-electrode and the metal anode prior to conventional charge and discharge cycling of the battery/cell (which takes place in a non-inert environment) where reactive reduced oxygen species are formed. The disclosed processes provide commercial scale manufacturing capabilities that are less complex than prior SEI formation processes, require less labor and cost less, yet provide superior protection of carbon-based air-electrodes and/or metal anodes. The disclosed processes may be used for Li—O₂ batteries or Li-air batteries, or may be applied to other suitable battery systems as would be known to those of ordinary skill in the art having had the benefit of reading this disclosure.

In one embodiment the pretreatment process comprises providing a complete battery system, and exposing at least one of the electrodes in situ, in an inert atmosphere, to the electrolyte. The process further comprises applying a voltage to the electrode in situ in the inert atmosphere while the electrode is exposed to the electrolyte to make preformed SEI film on the electrode. The voltage is applied to the electrode while the battery/cell maintains an inert atmosphere, and the electrode is exposed to the electrolyte, and in some embodiments the voltage is applied and held for a specified period of time. The presently disclosed processes are carried out prior to charge and/or discharge cycling of the battery or cell system to produce or store energy (i.e., “regular cycling” or “cycling”).

The disclosed pretreatment process may be performed with a metal-air or metal-oxygen battery system having any suitable carbon-based electrode such as a carbon-based electrode including a binder of 1%-40% by weight, preferentially 10-20%, more preferentially 2%-25%, or even more preferentially 5%-15% by weight. In certain embodiments the air electrodes comprise carbon fibers, graphene, carbon nanotubes, graphite, carbon cloth, carbon foam, or any mixture thereof. In certain embodiments the air electrodes comprise suitable carbon material (e.g., carbon fibers, graphene, carbon nanotubes, graphite, etc.) in combination with at least one functional catalyst, such as RuO₂, Pt, Ru, Au, Pd, Ir, IrO₂, MnCo₂O₄, and ZnCo₂O₄.

The disclosed pretreatment processes may be used with the typical electrolytes or any suitable electrolyte for use in a metal-air or metal-oxygen battery/cell system. In certain of the disclosed embodiments the electrolyte comprises, consists essentially of, or consists of, LiTf-tetraglyme. In other embodiments the electrolyte comprises, consists essentially of, or consists of, lithium bis(trifluoromethanesulfonyl)imide (LiTFSI)/ether-based electrolytes with 1,2-dimethoxyethane or DME, diglyme, triglyme, tetraglyme, or mixture of the same as solvent, lithium bis(pentafluoroethanesulfonyl)imide (LiBETI)/ether-based electrolytes (DME, diglyme, triglyme, tetraglyme), or LiTf/ether-based electrolytes (DME, diglyme, triglyme). The concentration of the electrolytes can be that at which the battery system will eventually operate, such as from 0.5 to 5 M. Other suitable electrolytes and concentrations for the same may be used depending on the type of metal-air battery system being used, as is known to those of ordinary skill in the art having had the benefit of reading this disclosure or knowing of the present inventions disclosed herein.

The inert atmosphere for the disclosed pretreatment process may comprise any suitable inert gas. In certain of the disclosed embodiments the inert atmosphere comprises, consists essentially of, or consists of, argon, helium, neon, nitrogen, nitrogen dioxide, nitrogen monoxide or any combination thereof. In some embodiments, the inert atmosphere comprises, consists essentially of, or consists of argon, nitrogen, helium, or neon gas. The inert atmosphere needs to be free of or substantially free of oxygen or oxygen containing compounds or mixtures.

The disclosed pretreatment processes may include a voltage applied to the electrode, in situ, in the inert atmosphere while the electrode is exposed to the electrolyte, to make a preformed SEI film. The voltage applied may be from 0.01 V to 5 V, or 0.5 V to 5 V, or 1 V to 4.5 V, or 2 V to 4.5 V, or 3 V to 4.5 V, or 4 V to 5 V, or 4.2 V to 4.5 V, or 4.3 V, or 4.4 V, or 4.5 V. The time period during which the voltage is applied to the electrode to form the SEI film may be from 0.01 minutes for up to 2 hours, or from 15 seconds up to 60 minutes, or from 1 minute up to 45 minutes, or from 5 minutes up to 30 minutes, or for 0 minutes, or for 0.1 minutes, or 1 minute, or 2 minutes, or 3 minutes, or 4 minutes, or 5 minutes, or 6 minutes, or 7 minutes, or 8 minutes, or 9 minutes, or 10 minutes, or 15 minutes, or 20 minutes, or 60 minutes, or 120 minutes, or for some time period there between. In certain embodiments the charge, such as 4.3 V, is held for 10 min. The electrode(s) in certain embodiments is charged under an inert atmosphere to 4.3 V followed by holding at 4.3 V for a time period, such as for a time period of from 0 minutes up to 2 hours, or from 15 seconds up to 60 minutes, or from 1 minute up to 45 minutes, or from 5 minutes up to 30 minutes, or for 0 minutes, or 1 minute, or 2 minutes, or 3 minutes, or 4 minutes, or 5 minutes, or 6 minutes, or 7 minutes, or 8 minutes, or 9 minutes, or 10 minutes, or 15 minutes, or 20 minutes, or 60 minutes, or 120 minutes, or for some time period there between. In certain embodiments the charge, such as 4.3 V, is held for 10 min.

Certain embodiments of the pretreatment processes comprise simultaneously or substantially simultaneously exposing a metal-air (or metal-oxygen) battery cathode and a lithium, sodium, or potassium anode, while the electrodes are positioned in a complete battery system (i.e., in situ), to the electrolyte, in an inert atmosphere while applying a voltage thereto, thereby making a preformed SEI film on the cathode and anode. In other embodiments the method for pretreating metal-air (or metal-oxygen) battery electrodes comprises exposing a carbon-based cathode and/or a lithium metal anode to a lithium-air battery electrolyte in an inert atmosphere, in situ to make preformed SEI films thereon. In certain embodiments a voltage is applied to the electrodes while in situ in the inert environment, to make the preformed SEI film.

In certain embodiments the disclosed process for pretreating metal-air (or metal-oxygen) battery electrodes comprises exposing a carbon-based material or carbon-based material/catalyst composite cathode and/or a lithium (or sodium, potassium, zinc, magnesium, aluminum, or iron) metal anode, in situ, to an electrolyte in an inert atmosphere.

In particular embodiments the disclosed pretreatment process comprises exposing an in situ CNTs-material or CNTs-catalyst composite air electrode, and/or a metal anode, e.g., lithium, sodium, or potassium metal anode, to the electrolyte while in an inert atmosphere and applying a voltage to the electrode(s). In certain embodiments the cathode is formed of a carbon-catalyst composite material. In some embodiments the carbon of the carbon-catalyst comprises CNTs. In certain embodiments the catalyst of the carbon-catalyst composite comprises ruthenium oxide. Also disclosed herein are pretreated catalyst-decorated carbon based air electrodes, such as CNTs-based air-electrodes for metal-air or metal-oxygen battery systems/cells (e.g., Li—O₂ batteries or cells). Here, catalyst-decorated carbon based air electrode means that functional non-carbon catalysts (Ru, RuO₂, IrO₂, Au, Ag, Pt/Au, Pd, Pt, MnO₂, Co₃O₄, MnCo₂O₄, ZnCo₂O₄) are incorporated with highly-conductive carbon materials (carbon fiber, graphene, carbon cloth, carbon foam) to form catalyst/carbon composites. In certain embodiments a RuO₂ catalyst is used in a composite with the CNTs to form the air-electrodes. Certain embodiments of the disclosed processes, such as the pretreatment process of charging to 4.3 V followed by holding at 4.3 V for 10 minutes, are performed on RuO₂/CNTs electrodes. Other catalysts for a catalyst/carbon composite material for the air electrodes may be used, such as Ru, RuO₂, IrO₂, Au, Ag, Pt/Au, Pd, Pt, MnO₂, Co₃O₄, MnCo₂O₄, ZnCo₂O₄ or any combination thereof.

Certain embodiments of the disclosed processes include an air electrode or cathode for a metal-air or metal-oxygen battery, formed of carbon fibers, graphene, carbon nanotubes, graphite or any mixture thereof, and a metal anode comprising, consisting essentially of or consisting of a lithium, sodium or potassium metal anode or compounds containing lithium, sodium or potassium.

In certain embodiments of the disclosed processes at least one electrode for a metal-air or metal-oxygen battery is charged with an areal current density from 0.01 mA cm⁻² to 5 mA cm⁻², or from 0.05 mA cm⁻² to 2 mA cm⁻², or from 0.08 mA cm⁻² to 0.5 mA cm⁻², or from 0.1 mA cm⁻² to 0.3 mA cm⁻² based on an rea of the air or oxygen electrode.

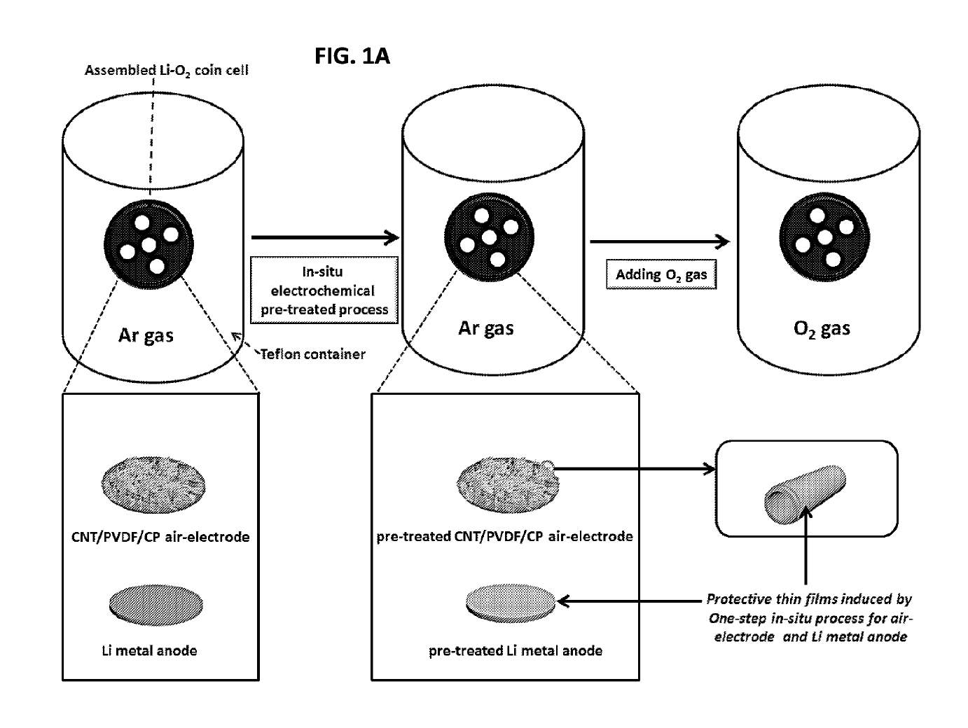

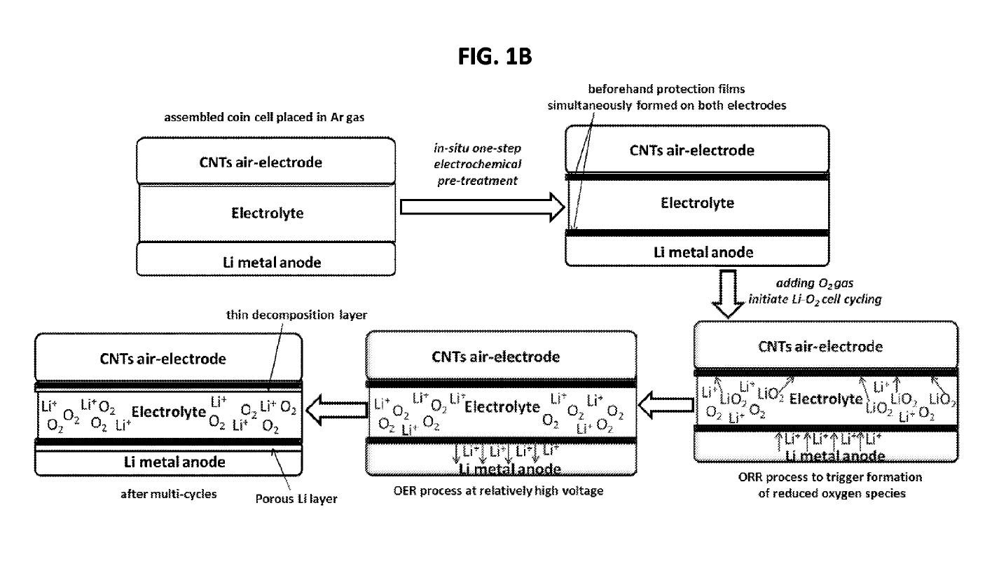

An embodiment of the disclosed pretreatment process is schematically illustrated in FIG. 1(a) in application to a lithium-air battery system, though can be used with any suitable metal-air or metal-oxygen battery system or cell, or other suitable battery system. Although illustrated as a lithium-air battery system in FIG. 1(a), it is understood the same process is applicable to other metal-air or metal-oxygen battery systems.

Also disclosed are preformed SEI films on metal-air or oxygen electrodes. The preformed SEI films are created from the decomposition of electrolyte during the in-situ electrochemical pre-charging process in an inert environment. The preformed SEI films can protect both the air-electrodes and the metal anode prior to conventional battery charging/discharging cycling where reactive reduced oxygen species are formed. The cells pretreated in the oxygen-free (or substantially oxygen free) environment demonstrate significantly improved cyclying stability when operated in the regular O₂ atmosphere in which metal-air and/or metal-oxygen batteries operate to charge and discharge. The cycling stability of pretreated metal-air and metal oxide batteries has been shown to improve by as much as greater than 50%, 60%, 70%, 80%, 90%, 100%, 110% and more as compared to the same battery systems that were not pretreated using the disclosed process. The preformed SEI film compositions and surface morphologies of pretreated carbon-based electrodes and Li metal anodes provide the fundamental mechanism behind the improved electrochemical performance of such batteries/cells.

In certain embodiments the preformed SEI films formed on air or oxygen electrodes are comprised of, consist essentially of, or consist of lithium, carbon, nitrogen, oxygen, fluorine, and sulfur. In certain embodiments the preformed SEI film on the air electrode comprises by weight of the total SEI film, lithium at from 1 wt % to 15 wt % [broad range] or from 5 wt % to 10 wt % [narrow range], and carbon at from 30 wt % to 65 wt % [broad range] or from 50 wt % to 60 wt % [narrow range], and nitrogen at from 0.5 wt % to 20 wt % [broad range] or from 2 wt % to 10 wt % [narrow range], and oxygen at from 20 wt % to 40 wt % [broad range] or from 30 wt % to 35 wt % [narrow range], and fluorine at from 5 wt % to 15 wt % [broad range] or from 8 wt % to 12 wt % [narrow range], and sulfur at from 1 wt % to 8 wt % [broad range] or from 2 wt % to 5 wt % [narrow range].

In certain embodiments the preformed SEI film on the anode comprises by weight of the total SEI film, lithium at from 1 wt % to 30 wt % [broad range] or from 3 wt % to 10 wt % [narrow range], and carbon at from 10 wt % to 50 wt % [broad range] or from 20 wt % to 40 wt % [narrow range], and nitrogen at from 0.5 wt % to 20 wt % [broad range] or from 2 wt % to 10 wt % [narrow range], and oxygen at from 10 wt % to 30 wt % [broad range] or from 15 wt % to 25 wt % [narrow range], and fluorine at from 0.1 wt % to 10 wt % [broad range] or from 0.5 wt % to 5 wt % [narrow range], and sulfur at from 0.1 wt % to 10 wt % [broad range] or from 0.5 wt % to 5 wt % [narrow range].

In particular embodiments the preformed SEI films comprise the components shown in Table 1. The tables below show comparisons of the compositions of the surfaces of an untreated air electrode and anode (called “Pristine”) and pretreated air electrodes having the preformed SEI films of the present invention thereon (referred to as “Treated”). The pristine air electrode surface is comprised primarily of carbon from the CNTs, C—F from the PVDF binder, some C—O for partially oxidized carbon species, F-species from the C—F, and some oxygen likely due to adsorbed oxygen species in air or partially oxidized carbon species. No detectable sulfur is present in the pristine air electrode. In contrast, shown is the composition of the pretreated electrode having a preformed SEI film on the surface, wherein the illustrated embodiment the pretreatment process included application of 4.3 V held at that voltage for 10 min, some solvent molecules (e.g., tetraglyme in this embodiment) and salt anions (e.g., trifluoromethanesulfonate, CF₃SO₃⁻ or Tf⁻) in the electrolyte decomposed at 4.3 V as indicated by the composition having both Li and S, increased F content, greatly increased oxygen content and reduced C content (Si originated from the glass fiber separator), as shown in Table 1.

In particular embodiments the preformed SEI films comprise the components shown in Table 2. The tables below show comparisons of the compositions of the surfaces of an untreated air electrode and a metal anode (called “Pristine”) and pretreated anodes having the preformed SEI film of the present invention thereon (referred to as “Treated”). The pristine lithium anode surface compositions are primarily Li, some C species and trace amount of oxygen species, where the latter two components are likely contamination of Li metal by moisture and CO₂ in air, which is normal to commercial Li metal samples. Similar to the pretreated air electrodes, the metal anode after the pretreatment process has a preformed SEI film including Li, F, S, C and oxygen, the carbon and oxygen primarily C═O. The increased C═O content in is from electrolyte decomposition after pretreatment.

TABLE 1
Summary of atomic concentrations of XPS spectra for surfaces of
a 4.3 V/10 min pretreated CNT air electrode and a Pristine version
of the same CNT air electrode.

| | Li | C | O | F | S |
|---|---|---|---|---|---|
| Treated CNTs surface | 5.2 | 53.2 | 28.9 | 10.3 | 2.4 |
| Pristine CNTs surface | 0.0 | 88.4 | 3.6 | 8.0 | 0.0 |

TABLE 2
Summary of atomic concentrations of XPS spectra for surfaces of
the 4.3 V/10 min treated Li metal anode and the pristine Li metal
anode.

| | Li | C | O | F | S |
|---|---|---|---|---|---|
| Treated Li metal surface | 62.0 | 16.6 | 20.3 | 0.8 | 0.3 |
| Pristine Li metal surface | 74.6 | 24.1 | 1.3 | 0.0 | 0.0 |

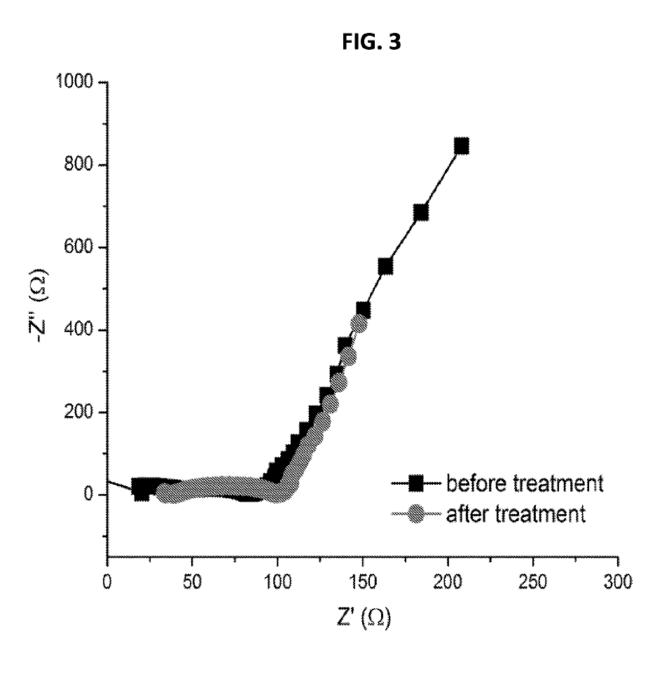

In certain embodiments the preformed SEI films are uniform or substantially uniform on the electrode. Substantially uniform as used herein means the thickness of the preformed SEI films do not vary more than 20%, preferably not more than 10%, on the electrode surface. In some embodiments surface roughness of the SEI films increases more rapidly when the voltage is larger than, e.g., 3.7 V, though the surface roughness change of the preformed SEI films reaches a plateau when the charging time at, e.g., 4.3 V is from 0 min to 10 min. Then, in certain embodiments the preformed SEI film surface becomes rougher once the time period increases to 15 min and then 20 min. The thickness of the preformed SEI films gradually increases from <1 nm to 1˜2 nm, 3˜4 nm, 5˜6 nm and 8˜9 nm as a constant voltage charging time increases from 0 min to 5 min, 10 min, 15 min and higher. A preferred preformed SEI film thickness may be at least 2 nm, or at least 2.5 nm, or at least 3 nm. The thickness of the SEI film depends upon the voltage applied and the holding time period. An example of the uniform preformed SEI film can be seen, for example, in FIGS. 3(b)-3(g), discussed below.

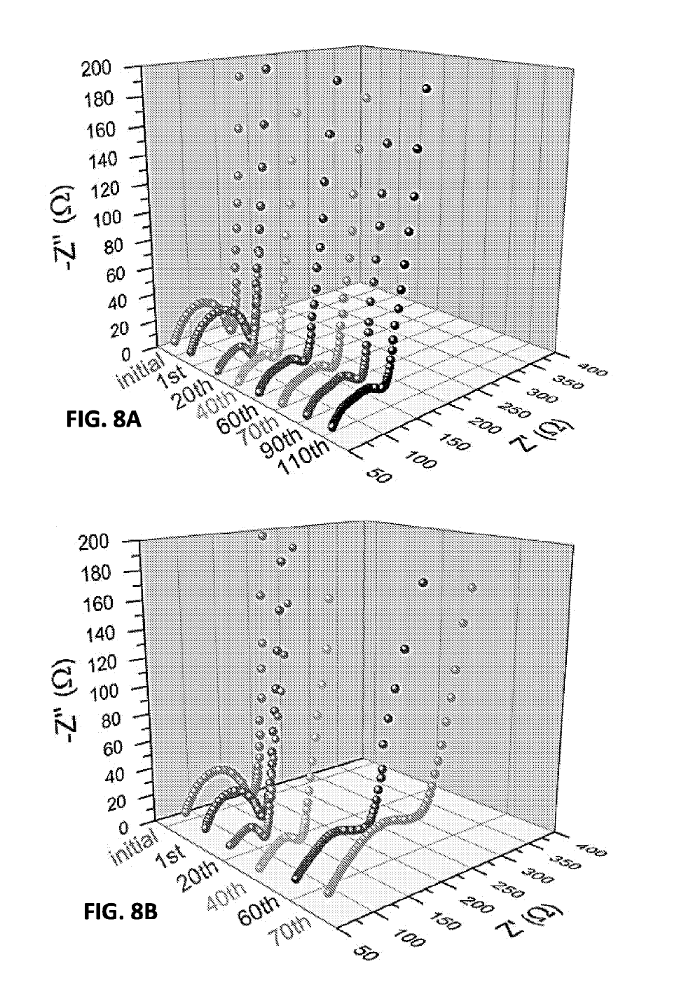

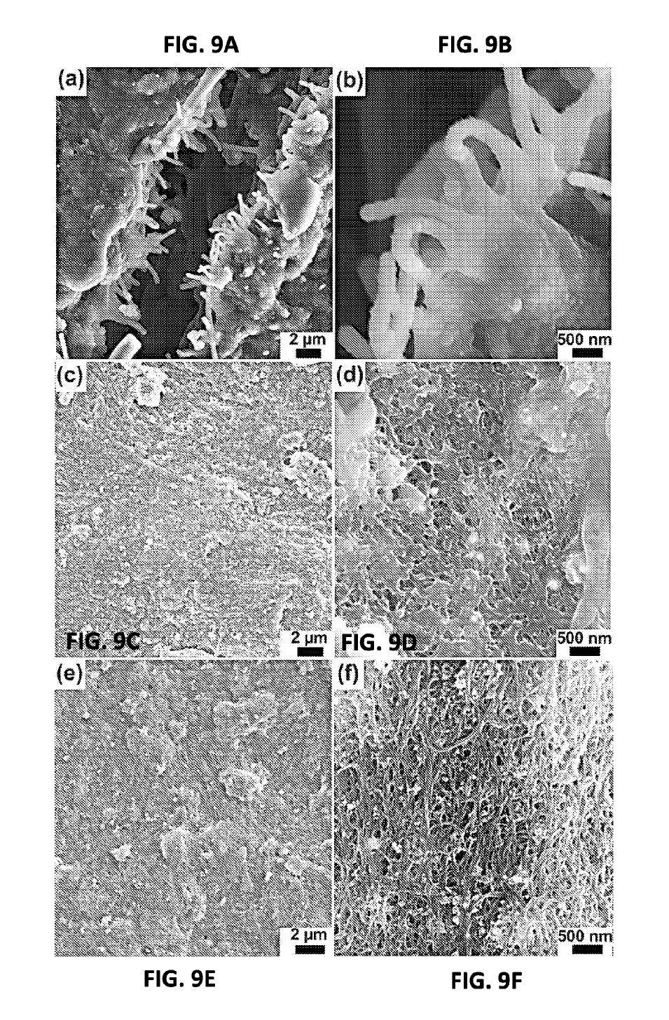

The inventors believe that the mechanism of the preformed SEI films' protection of either or both electrodes in the metal-air (or metal-oxygen) batteries/cells is illustrated via the embodiments illustrated in FIG. 1(b). In this illustration an assembled LilICNTs coin cell is placed in an Ar-filled container is pretreatment followed by holding at a preferred voltage and holding time period to promote appropriate electrolyte decomposition, which results in simultaneous formation of preformed SEI films on both the CNTs of the cathode and the Li metal of the anode, prior to the subsequent Li—O₂ battery cycling. The Li—O₂ cell cycling can be initiated after adding O₂ into container (following completion of the preformed SEI film process and formation. During the ORR process, the uniform thin film layers formed on CNTs' surfaces can protect the CNT air electrode against reductive oxygen species (particularly LiO₂). The OER process of carbon-based air-electrode without functional catalysts or redox mediators is associated with a relatively high voltage upon cell charging (more than 4 V), which favors the oxidation of bare carbon. However, the protection from the preformed SEI film on the CNT air electrode significantly suppresses the oxidation of carbon. After long-term use of the battery through the regular charge/discharge cycles, the morphology and size of pretreated air electrode surface is maintained without notable volume swelling caused by the oxidation. Only thin electrolyte decomposition on air-electrode was observed, as shown in FIGS. 8c and 8d. There is an obvious significantly higher stability of the disclosed pretreated carbon-based air-electrode as compared to the non-treated battery electrode (FIG. 8a, 8b). In the case of the Li metal anode, the repeated Li plating and stripping causes lithium ions to shuttle through the preformed SEI film. The protection of the preformed SEI film greatly stabilizes the Li metal surface after even 110 cycles, as shown in FIG. 9d. Even though limited porous Li layers still form on the top of the Li metal surface during plating and stripping of Li metal, most of the Li metal remains with its initial structure and thickness (FIG. 9c). This indicates that the uniform preformed SEI-films formed on air-electrodes and Li anodes via the one-step, in-situ electrochemical pre-charging processes disclosed effectively protect the electrodes against side reactions during regular battery cycling.

### EXAMPLES

In one embodiment a Li∥CNTs coin cell (CR2032) was assembled by using a CNT/PVDF/CP air-electrode (where PVDF is polyvinylidene difluoride and CP is carbon paper), a separator, such as a glass fiber separator, a Li-metal anode, and 300 μL 1 M LiTf-tetraglyme electrolyte, and then transferred into a Teflon container in an Ar-filled glovebox. After an electrochemical pretreatment process for the coin cell in an Ar (or another inert) atmosphere, preformed protective thin-films (SEIs) are uniformly deposited onto the surfaces of the electrodes, such as CNT/PVDF/CP air-electrodes and the Li-metal anodes, in certain embodiments, simultaneously. Subsequently O₂ gas was added into the Teflon container to thoroughly replace the Ar gas and the conventional Li-air (Li—O₂) battery cycling (i.e., discharging/charging) was started. It can be seen that prior to the formation of highly-reactive reduced oxygen species under Li-air (Li—O₂) cell cycling, both carbon-based air-electrodes and Li-metal anodes have been efficiently protected by the in-situ formed thin-films. This pretreatment process as disclosed significantly enhances the stability of both carbon-based air-electrodes and Li-metal anodes and thus improves the cycling stability of the rechargeable Li-air (Li—O₂) battery.

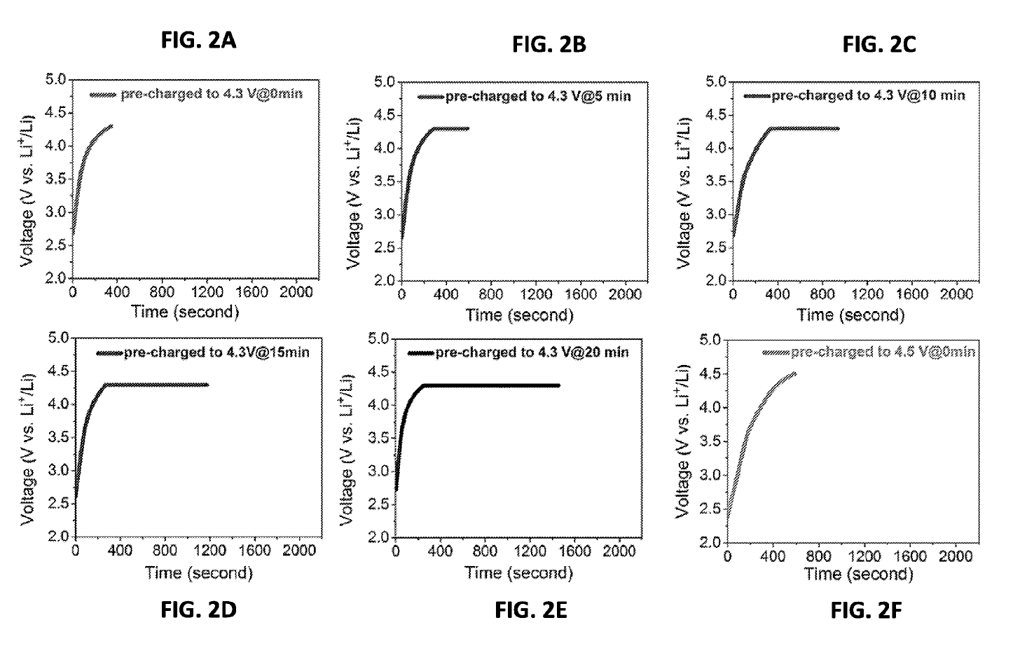

In one example the pretreatment of an assembled Li∥CNTs cells was conducted by charging the cells in an Ar gas atmosphere from open-circuit voltage (OCV) to 4.3 V vs. Li/Li⁺ at 0.1 mA cm⁻² and then holding the cells at 4.3 V or to 4.5 V, or to 4.8V or to 5 V, for 0 min, 5 min, 10 min, 15 min and 20 min, respectively. The electrochemical charging curves for assembled cells are shown in FIGS. 2(a)-(f). In addition, the electrochemical impedance spectra of the Li∥CNTs cells tested before and after pretreatment at 4.3 V/10 min indicate that the in-situ preformed SEI films during the pretreatment process do not significantly affect the total impedance of the cells, as shown in FIG. 3. After pretreatment, the cells were disassembled, the CNTs electrodes and the Li metal anodes were washed with fresh anhydrous 1,2-dimethoxyethane (DME) and then dried. The morphologies of the pristine CNTs electrode and the aforementioned pretreated CNTs electrodes were characterized by high resolution transmission electron microscopy (HR-TEM) and the compositions of the films on the surfaces of CNTs electrodes and Li-metal anodes were analyzed by X-ray photoelectron spectroscopy (XPS).

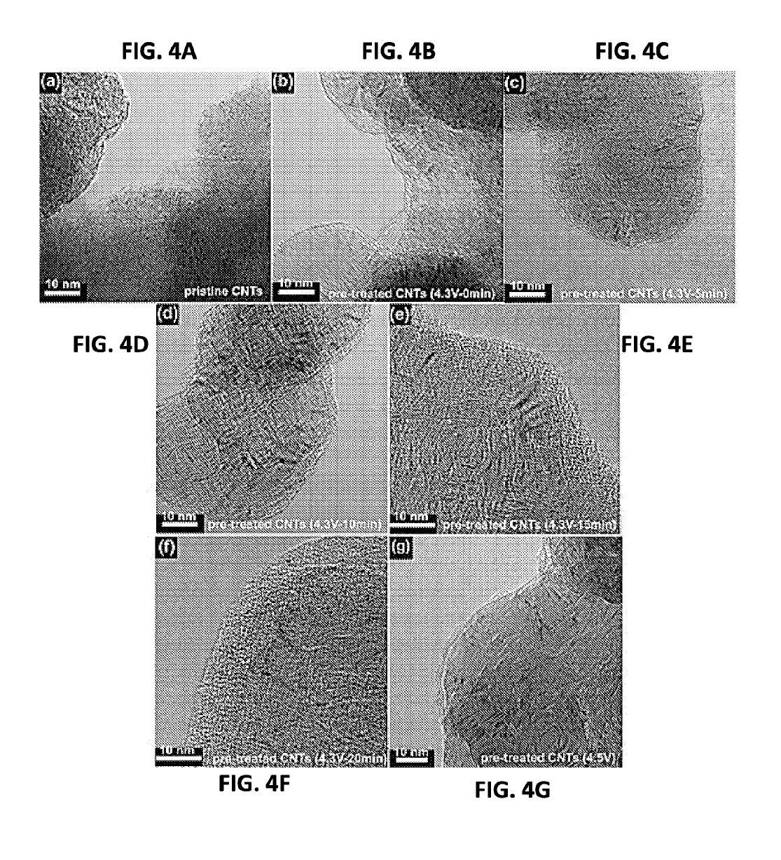

FIG. 4(a) shows that a pristine CNT electrode surface (pristine as used herein means not exposed to electrolyte or charge) has a clean surface. However, after the aforementioned different pretreated processes (charged to 4.3 V, charged to 4.3 V followed by holding at 4.3 V for 5 min, 10 min and 15 min, and 20 min and charged to 4.5 V or other voltages as disclosed herein), the CNTs electrodes have a uniform or substantially uniform coating layer deposited onto the CNTs surface, and the thickness of the coating film gradually increases from <1 nm to 1˜2 nm, 3˜4 nm, 5˜6 nm, 8˜9 nm, and 1˜2 nm, respectively, as shown in FIGS. 4(b)-4(f). This is because the ether- and glyme-based electrolytes normally have oxidation decomposition voltages at about 4.0 V vs. With Li/Li⁺, the charging to and maintaining at 4.3 V cause the electrolyte to decompose and the longer time period this is maintained, the more the electrolyte will be oxidized, so the deposition of undesirable products on electrode surfaces, or the thickness of the decomposition films on the cathodes, such as a CNTs electrode, will be increased.

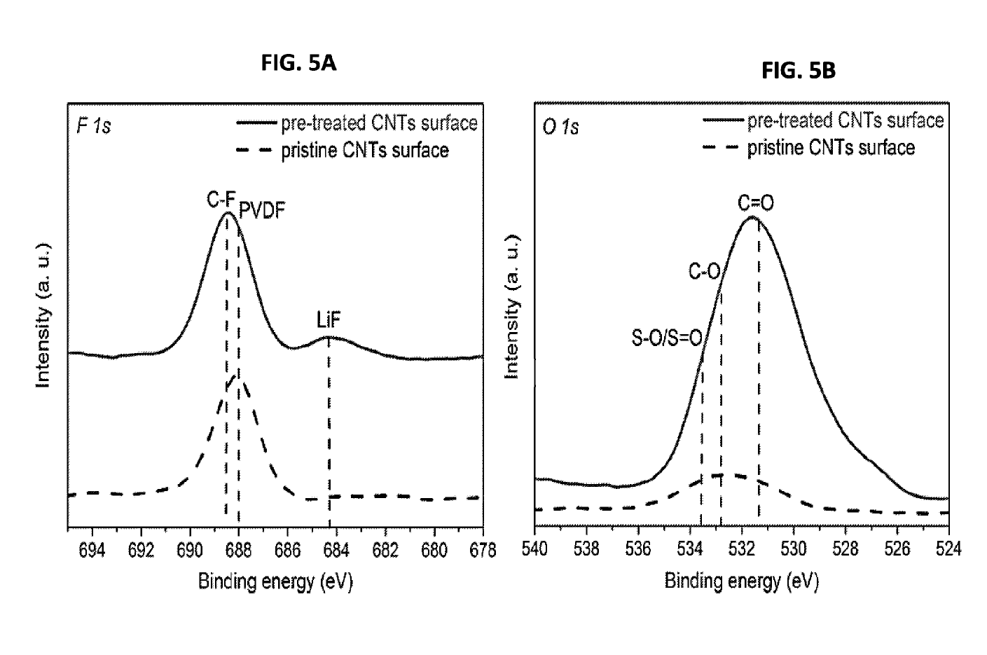

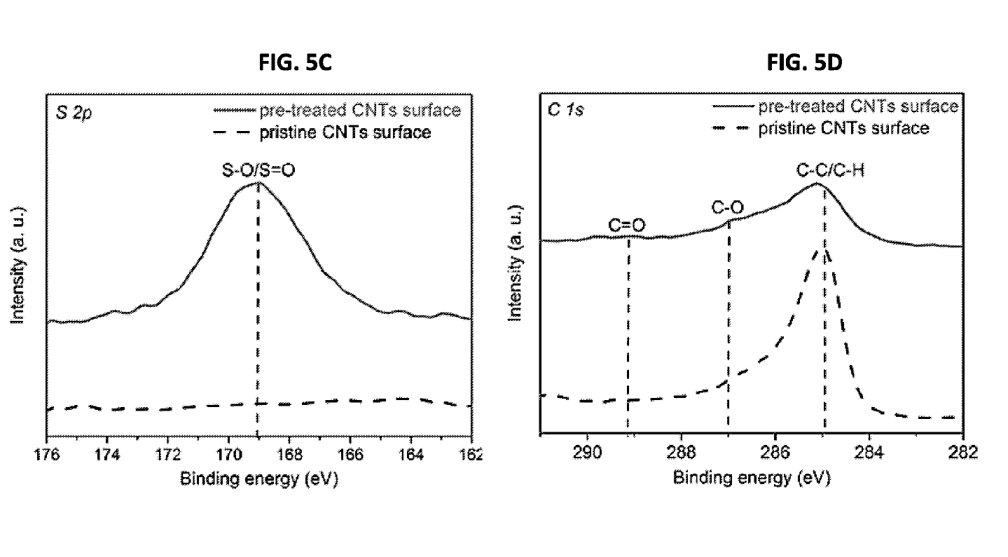

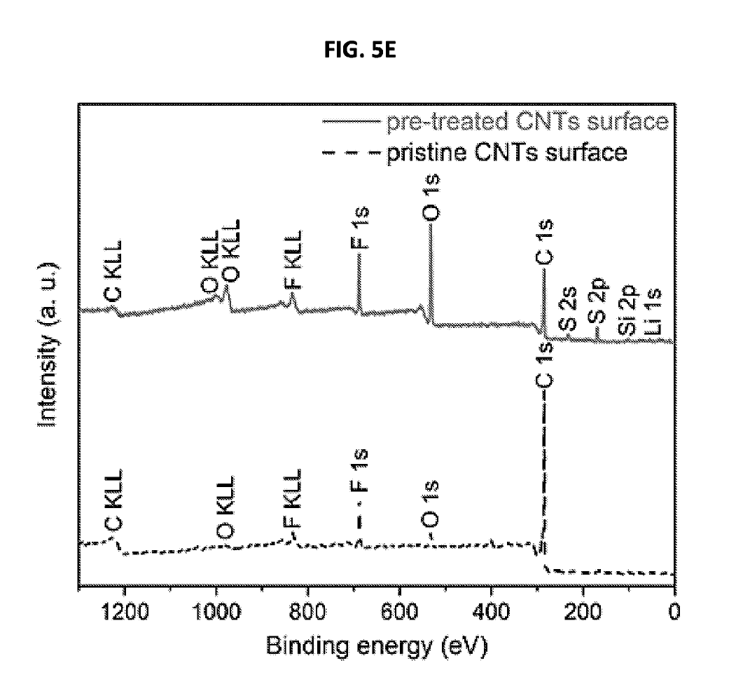

Compositions of the preformed SEI, such as the preformed thin film on the electrode surface during the 4.3 V/10 min pre-charging treated cathodes (CNTs electrode selected as an example) are shown in FIGS. 5(a)-(e) with comparison of those of the pristine CNTs electrode. The element components in the preformed protective thin-film on the pretreated CNTs electrode and the surface film on pristine CNTs electrode are shown in the narrow scan XPS spectra in FIGS. 5(a)-(d) and the related atomic concentrations are summarized in Table 3. The pristine CNTs electrode surface contains mainly carbon for CNTs, C—F for PVDF binder and some C—O for partially oxidized carbon species (see FIG. 5(d)), some F-species per the C—F bond at 688.0 eV that is ascribed to the PVDF binder (FIG. 5(a)), and a small amount of oxygen probably due to the adsorbed oxygen species in air or partially oxidized carbon species (FIG. 5(b)). No Li and/or S are detected for the pristine CNTs electrode (FIG. 5(e).

After the electrode is pre-charged to 4.3 V and held at that voltage for 10 min, some of the electrolyte solvent molecules (for example, tetraglyme) and salt anions (e.g., trifluoromethanesulfonate, CF₃SO₃⁻ or Tf⁻) in the electrolyte decomposed at 4.3 V as indicated by the newly appearing Li and S, increased fluoride content, greatly increased oxygen content and reduced carbon content. In the case of F 1s spectra (FIG. 5(a)), the treated CNTs electrode shows a C—F peak at 688.0 eV for PVDF, another C—F peak at 688.5 eV corresponding to the CF₃ group in the CF₃SO₃⁻ like species and a third peak at 684.4 eV for LiF, where the latter two are likely from the decomposition of CF₃SO₃Li salt. A significant and broad peak in oxygen 1s spectrum (FIG. 5(b)) indicates the existence of C═O (531.4 eV) and C—O (532.9 eV), and S—O/S═O (533.6 eV), which are from the oxidative decomposition of the tetraglyme solvent during the pre-charging process. The S—O/S═O peaks centered at 169.1 eV in S 2p spectrum (FIG. 5(c)) are likely from the salt decomposition after the in-situ electrochemical pretreatment process. Much lower amount of C—C/C—H originated from CNTs indicates CNTs surfaces have been covered by protective thin-films, as shown in FIG. 5(d). The significant element components in the protective thin-films on the pretreated CNTs electrode are shown in the wide scan XPS spectra in FIG. 5(e).

TABLE 3

| | Li (%) | C (%) | O (%) | F (%) | S (%) |
|---|---|---|---|---|---|
| Treated CNTs surface | 5.2 | 53.2 | 28.9 | 10.3 | 2.4 |
| Pristine CNTs surface | 0.0 | 88.4 | 3.6 | 8.0 | 0.0 |

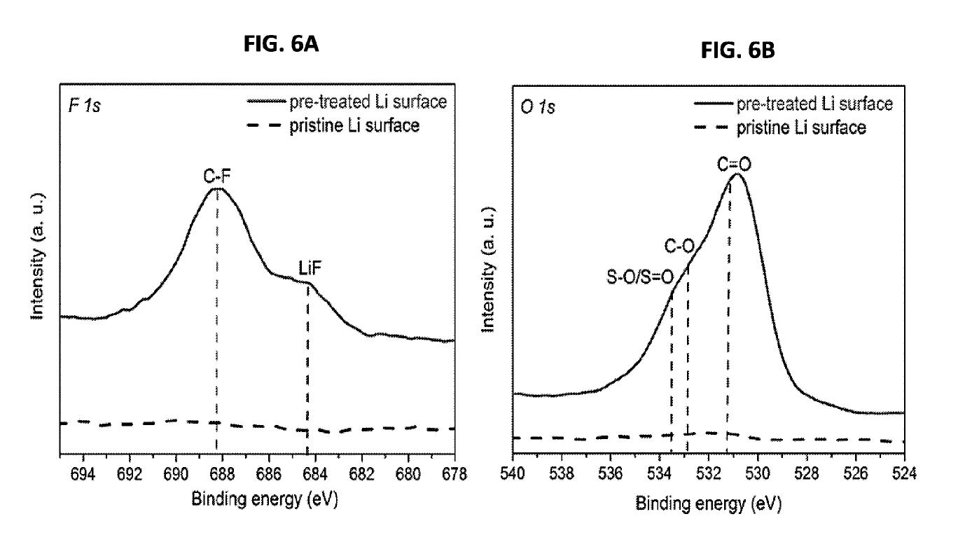

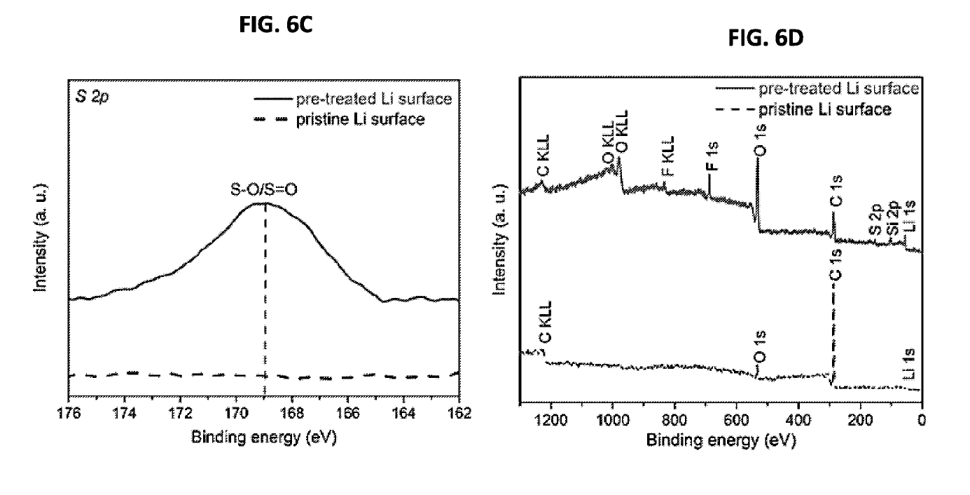

The SEI films' compositions of the 4.3 V/10 min pre-charging treated Li-metal anode and the pristine Li metal were also characterized by XPS and the results are shown in FIGS. 6(a)-(d) and summarized in Table 4. There is primarily Li, some carbon species and a trace amount of oxygen species on the pristine Li-metal surface, where the latter two are normally from contamination of Li metal by moisture and CO₂ in air during the anode manufacturing, which is normal to commercial Li metal samples. The F 1s spectrum of the treated Li-metal anode surface (FIG. 6(a)) show the C—F peak at 688.5 eV for the CF₃ groups on the reduced CF₃SO₃ species and the LiF peak at 684.4 eV, both of which are likely due to decomposition of CF₃SO₃Li salt on the Li anode surface during the in-situ electrochemical pretreatment process. Three peaks (C—O at 532.7 eV, C═O at 531.5 eV, and S—O/S═O at 533.6 eV) in O 1s spectrum of the treated Li-metal anode surface are attributed to electrolyte decomposition (FIG. 6(b)). The S 2p spectrum of the treated Li-metal anode surface indicates that the S—O/S═O peak centered at 169.0 eV is likely from lithium salt decomposition (FIG. 6(c)). Similar to the XPS results for CNT electrodes, after the pretreatment process, there are new elements, F and S, present and a significant increase in oxygen content on the treated Li-metal surface (FIG. 6(d)). These results confirm that the thin films formed on both CNTs electrode and Li-metal anode surfaces are likely due to decompositions of both salt anions and solvent molecules during the in-situ electrochemical pretreatment process, which aid in stabilizing both the CNTs electrode and the Li-metal anode during subsequent Li-air (Li—O₂) battery cycling.

TABLE 4

| | Li (%) | C (%) | O (%) | F (%) | S (%) |
|---|---|---|---|---|---|
| Treated Li | 62.0 | 16.6 | 20.3 | 0.8 | 0.3 |
| metal surface | | | | | |
| Pristine Li | 74.6 | 24.1 | 1.3 | 0.0 | 0.0 |
| metal surface | | | | | |

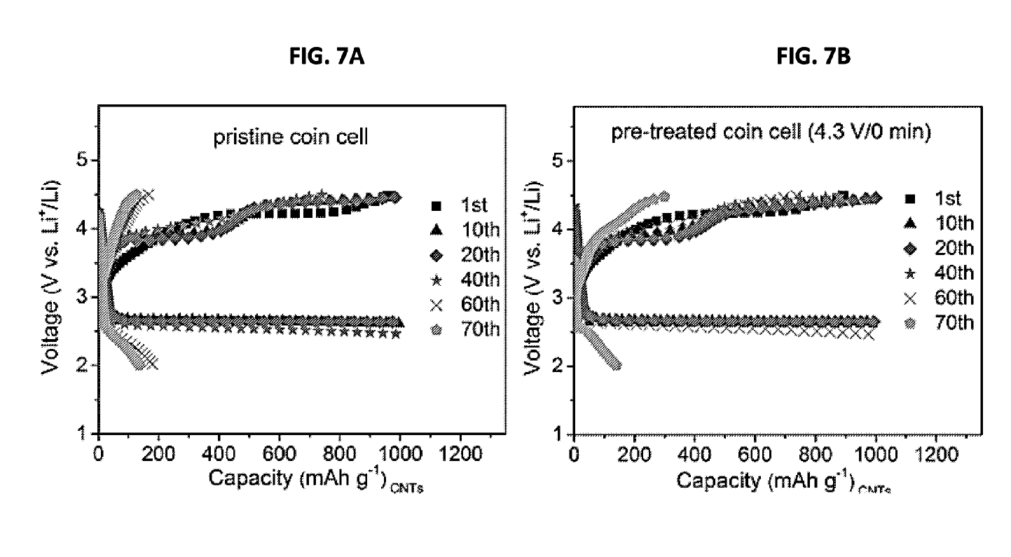

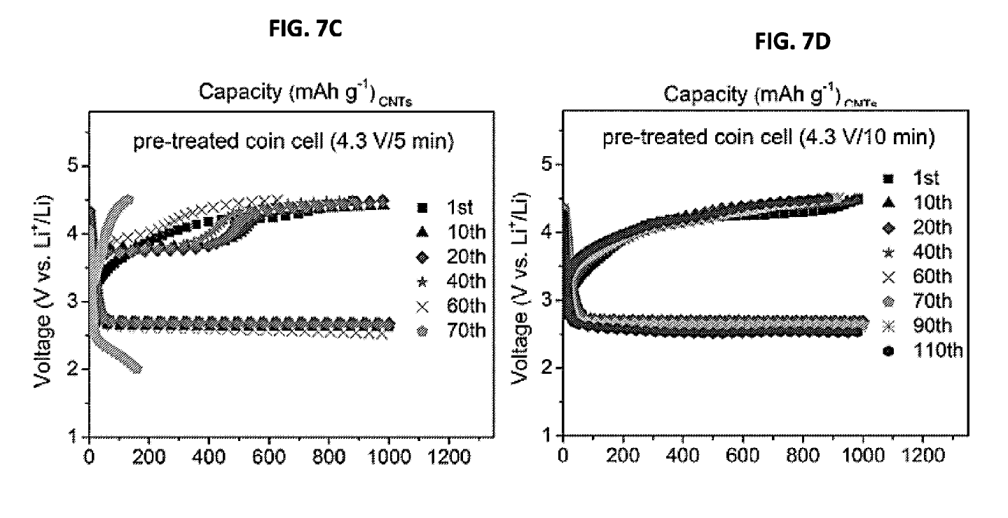

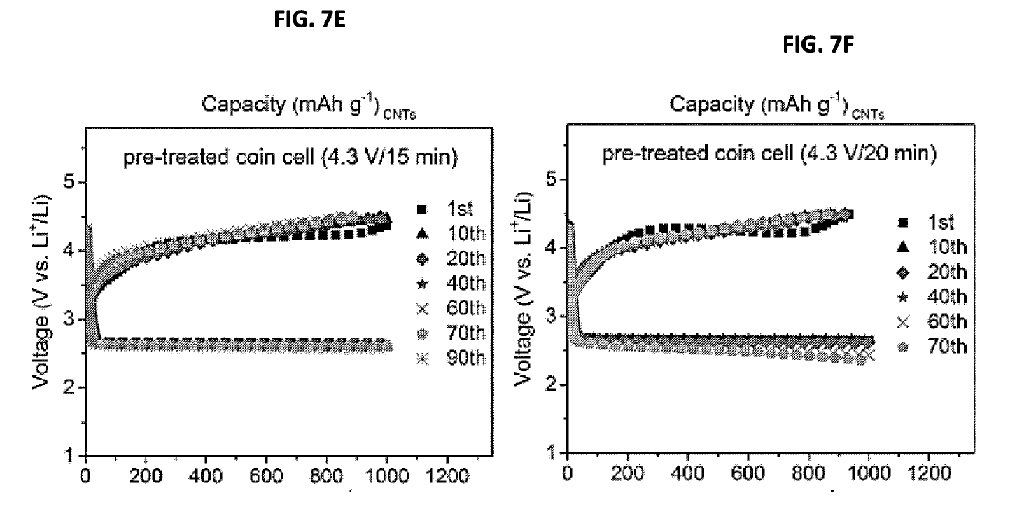

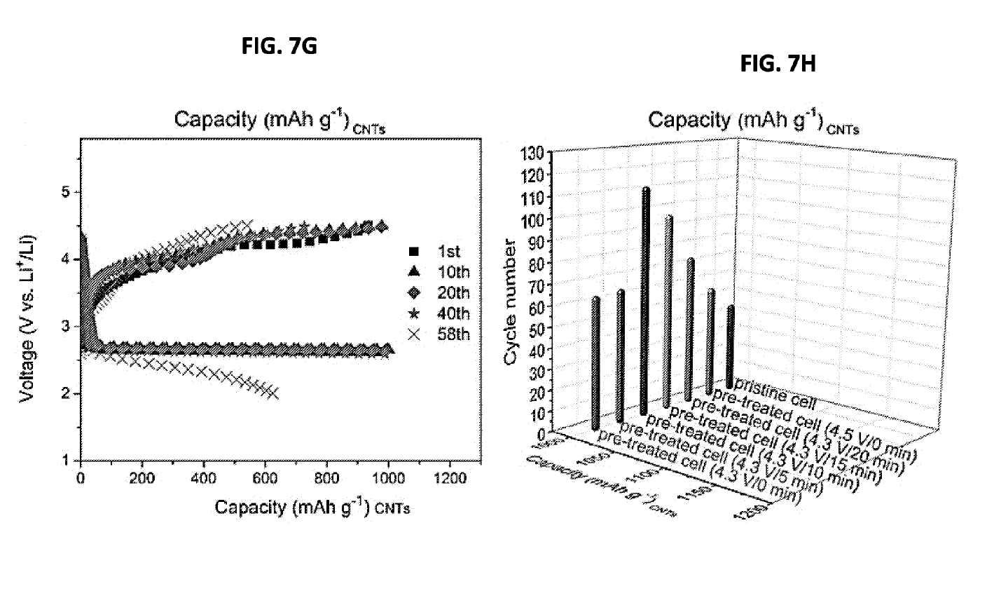

After the in-situ electrochemical pretreatment process, ultra-high-purity O₂ gas was added into the Teflon containers to thoroughly replace the Ar gas. Then the electrochemical performances of these Li-air (Li—O₂) coin cells were tested at 0.1 mA cm⁻² under the protocol of limited discharge/charge capacity of 1000 mAh g⁻¹. It is seen from FIGS. 7(a)-7(c) and FIG. 7(g) that the discharge/charge profiles of the Li—O₂ cells with the pristine CNTs electrode (FIG. 7(a)) and the CNTs electrodes by in-situ pretreatment at 4.3 V/0 min (FIG. 7(b)), 4.3 V/5 min (FIG. 7(c)), and 4.5 V/0 min (FIG. 7(g)) all show similar two-plateau features in the OER process during charging, where the first plateau at about 3.8 V during charging is attributed to the decomposition of Li₂O₂ and the second plateau at about 4.2 V is attributed to the decomposition of Li₂CO₃. The latter voltage is consistent with previous literature reports that a relatively high voltage (4.384.61 V) is required for electrochemical decomposition of Li₂CO₃. The similar two-plateau features of these three CNT electrodes indicate that the preformed SEI films (<2 nm thick, see FIGS. 7(b) and (c)) formed on CNTs during pre-charging at 4.3 V/0 min and 4.3 V/5 min do not change the OER behaviors of the carbon-based electrodes. In contrast, the charge profiles of the Li—O₂ cells with the CNTs electrodes by in-situ pretreatment (also referred to herein and in some figures as pre-charged) at 4.3 V/10 min (FIG. 7(d)), 4.3 V/15 min (FIG. 7(e)) and 4.3 V/20 min (FIG. 7(f)) all show dominantly one-plateau feature because the in-situ generated uniform thin films under these conditions are sufficient (>3 nm thick) and able to greatly reduce the oxidation of the carbon electrode and mitigate the decomposition of Li₂CO₃ in the OER process.

However, the pretreated carbon-based air electrodes at 4.3 V/0 min and 4.3 V/5 min result in at least 20 more stable cycles than does a pristine carbon-based air electrode, and these two pre-charging processes have very similar cycling stability. This is because the preformed SEI films on the surfaces of the carbon-based air electrodes have similar thicknesses of about 1 nm and even this ultrathin film can aid in protection of the carbon-based air electrodes and thus the cycling stability of the metal-air or metal-oxygen battery is thereby increased.

The corresponding stable cycle life numbers of Li-air (Li—O₂) cells with the disclosed pretreatment processed carbon-based air electrodes (4.3 V/0 min, 4.3 V/5 min, 4.3 V/10 min, 4.3 V/15 min, 4.3 V/20 min, and 4.5 V/0 min) and the pristine carbon-based air electrode are compared in FIG. 7(h), which are 62, 63, 110, 95, 72, 54, and 43, respectively. This phenomenon can be explained by the TEM characterizations (FIGS. 4(a)-(g)). The pristine carbon-based air electrode leads to the shortest stable cycle life because there is no any protective film on the carbon surface after the initial discharge process starts so reactions between carbon and reactive reduced oxygen species occur as listed below, during the discharge process.

C+Li₂O₂+½O₂→Li₂CO₃ (1)

C+2Li₂O₂→Li₂O+Li₂CO₃ (2)

The oxidation of carbon when the voltage exceeds 3.5 V during the charge process, as well as the regular electrolyte decompositions during the discharge and charge processes. After the pretreatment process disclosed herein some thin films form on the carbon-based air electrode surface and the thickness of this thin film is dependent upon the holding time at a particular voltage, e.g., 4.3 V or 4.5 V (see FIGS. 4(b)-4(g)). When the holding time at 4.3 V is 0 min and 5 min and holding time at 4.5 V is 0 min, the thin film is less than 2 nm thick. This ultrathin film does not provide full protection but does provide protection to a certain degree to the carbon electrode from the side reactions mentioned above, although it may not suppress the decomposition of the electrolytes. Thus, it improves cycling stability of the metal-air or metal-oxygen batteries by about 20 cycles. However, when a relatively long holding time is used, such as at 4.3 V, in the pretreatment process, i.e., 15 min and 20 min, it causes more electrolyte decomposition and thick, less-conductive films are produced on the carbon-based air electrode surface (although it is still in 5˜9 nm thick), thus increasing the cell impedance and inversely affecting the cycling stability of the metal-air or metal-oxygen, e.g., Li-air (Li—O₂), batteries. Therefore, a holding time of about 10 mins at 4.3 V for the in-situ pretreatment to the carbon-based air electrode is particularly useful as it results in 3˜4 nm thick protective film that well protects the carbon-based air electrodes and greatly enhances the cycling stability to up to 110 cycles or more, based on the one-step, in-situ pretreatment of the carbon-based air electrodes as disclosed herein.

FIGS. 8(a) and 8(b) show the results of measuring the variations of cell impedances with cycle time for Li-air (Li—O₂) cells with the carbon-based air electrode after the pretreatment process (i.e., 4.3 V/10 min), the pristine carbon-based air electrode, and the corresponding electrochemical impedance spectra (EIS) plots at the charged states. The “initial” in the figure means the stage of the cells/batteries were kept in an O₂ atmosphere for 3 hours before discharging. It is seen that the metal-air battery with the in-situ pretreated carbon-based air electrode at the initial stage has smaller values of electrolyte resistance (R_{b}), surface film resistance (R_{SEI}) and charge transfer resistance (R_{ct}) than that with the pristine carbon-based air electrode. This is because the Li-metal anode in the pretreated cell has already been well protected before O₂ was introduced so the reactions between Li, electrolyte and O₂ are limited, but the fresh Li-metal anode in the pristine battery/cell would have serious reactions between Li, electrolyte and O₂, thus producing a higher-resistant surface film and an increase in the values of R_{b}, R_{SEI} and R_{ct}.

After the first discharge/charge cycle, the Li-air (Li—O₂) batteries with both the pretreated and pristine carbon-based electrodes have similar R_{SEI} and R_{ct}. This is because the reactions of the electrolyte and the reactive reduced oxygen species formed during the ORR and the following OER processes are similar in these cells leading to similar electrolyte decomposition products, which cover the surfaces of both the carbon-based electrodes and Li-metal anodes, and the cells show close cell impedances after the first cycle. This is also the case for the following cycles until about the 20^{th} cycle. However, the cell impedances decrease from the 1^{st} cycle to the 20^{th} cycle, which may be due to both carbon-based air electrodes and Li-metal anodes, either pretreated or untreated, gradually reaching their own sufficiently protected condition with the coverage of the electrolyte decompositions that give lower cell impedances. After that, the cell impedances of the Li—O₂ cells begin to increase with cycling, but at a different pace. The metal-air/oxygen battery after the pretreatment (with 4.3 V for 10 mins) only shows a slight increase in cell impedance after the 110^{th} cycle, while the cell without pretreatment has a quick increase in cell impedance after the 70^{th} cycle. This is because the disclosed pretreatment process generates preformed SEI films on both the carbon-based electrode surface and Li-metal anode surface, which suppress the side reactions of reduced oxygen species attacking both the carbon-based electrode and the Li-metal anode as well as the further decompositions of electrolyte components. Therefore, the disclosed pretreatment process results in more effective protection to both carbon-based air electrodes and Li-metal anodes and much better cycling stability in cell impedance and cycle life than do untreated metal-air or metal-oxygen batteries/cells.

After cycling, the morphologies of related carbon-based air electrodes and Li-metal anodes were characterized by scanning electron microscopy (SEM). FIGS. 9(a)-(f) show SEM images at a surface view of the corresponding cycled carbon-based air electrodes with (a, b) and without (c, d) pretreatment compared with the pristine carbon-based air electrode (e, f). The SEM images of the carbon air electrode without pretreatment after 70 cycles have some large breakages on the air-electrode surface (FIG. 9(a)) and the thick side-reaction products from decompositions of carbon and electrolyte (FIGS. 9(a),(b)). The exposed bare carbon (here carbon nanotubes) became larger and thicker after 70 cycles (FIG. 9(b)), which is due to the serious side reactions of reactive, reduced oxygen species with electrolyte components and the carbon-based electrode, generating a lot of decomposition products covering on the carbon electrode surface. However, there are some coated films on the carbon electrode with pretreatment at 4.3 V/10 min after 110 cycles (FIGS. 9(c), (d)) when compared with the pristine carbon electrode (FIGS. 9(e), (f)) but the thickness and the coverage are significantly less than the carbon electrode without pretreatment. The SEI film is formed by the electrolyte decomposition during the discharge and charge processes. It indicates that the formation of a thin protective film on the carbon-based air electrode surfaces by the electrolyte decomposition during the in-situ pretreatment process greatly mitigates oxidation of the carbon by reduced oxygen species with high reactivity (especially O₂^{-•}).

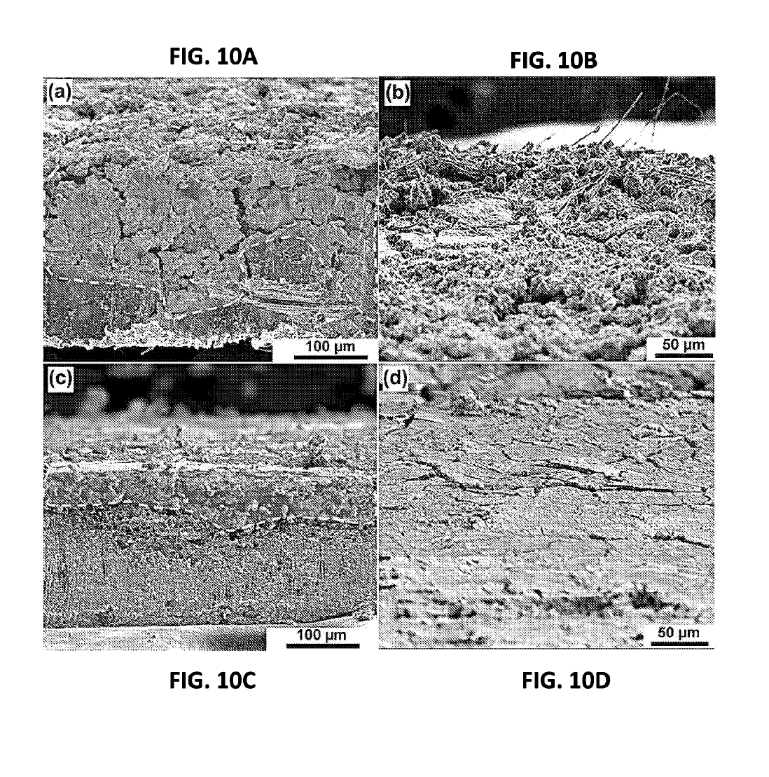

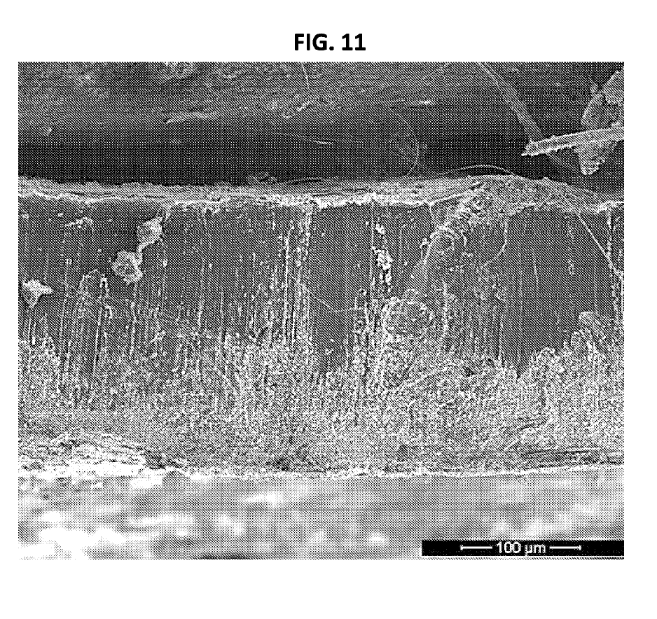

FIGS. 10(a)-(d) show SEM images of a cycled metal anode (here lithium though the same is true for sodium or potassium) with and without pretreatment. The metal anode without pretreatment after 70 cycles exhibits severe corrosion of the vast majority of bulk metal (FIG. 10(a)) and lots of corrosion products are loosely packed on the metal surface (FIG. 10(b)). However, with the pretreatment at 4.3 V/10 min the metal anode after 110 cycles still keeps thick bulk metal film without corrosion (FIG. 10(c)) and the surface film is relatively flat and compacted with only a few cracks (FIG. 10(d)), whose morphology is close to that of fresh Li metal (FIG. 11). It is indicated that one useful pretreatment process can also significantly protect the metal anode during long-term cycling thus leading to greatly enhanced cycling stability of the metal-air or metal-oxygen batteries/cells.

Embodiments of the processes disclosed herein provide a one-step, in-situ electrochemical process for efficient formation of protective uniform SEI films on air-electrodes and/or Li anodes, in some embodiments, simultaneously.

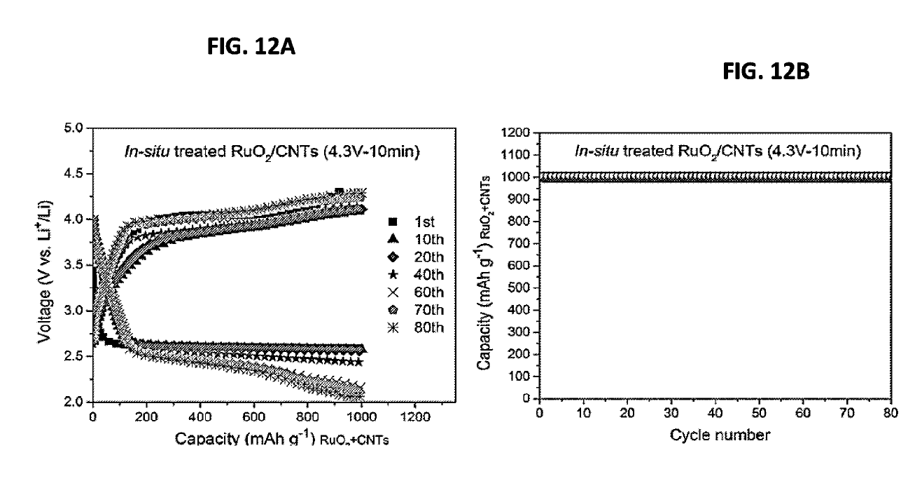

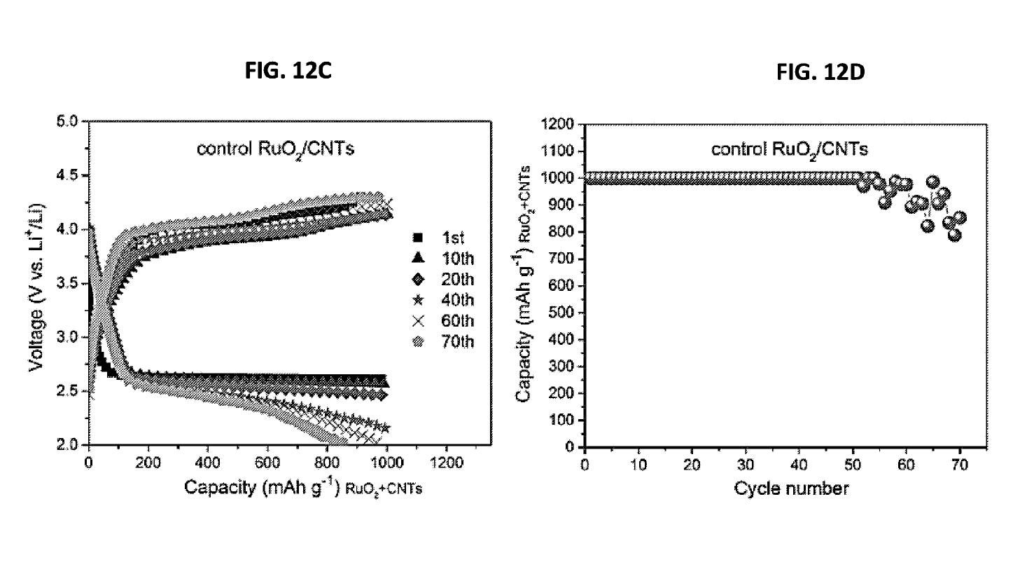

Also disclosed herein are pretreated catalyst-decorated CNTs-based air electrodes for metal-air or metal-oxygen batteries, such as Li—O₂ cells. In certain embodiments RuO₂, which is a conventional catalyst for oxygen evolution reaction (OER) in Li—O₂ batteries to lower the over-voltage during charging processes, are used in the CNTs-based air electrodes. In certain embodiments, the prior disclosed processes, such as the pretreatment process of charging to 4.3 V followed by holding at 4.3 V for 10 min are performed on RuO₂/CNTs-based air electrodes. The corresponding electrochemical characterizations are shown in FIGS. 12(a) and (b) and those for the pristine RuO₂/CNTs electrodes (i.e., without the disclosed pretreatment processes) are shown in FIGS. 12(c) and (d). The pretreated battery shows more stable cycle life (for at least 80 cycles) than the untreated battery (about 50 cycles). As such, this evidence supports the assertion that embodiments of the disclosed in-situ pretreatment processes are useful for a variety of air-electrodes.

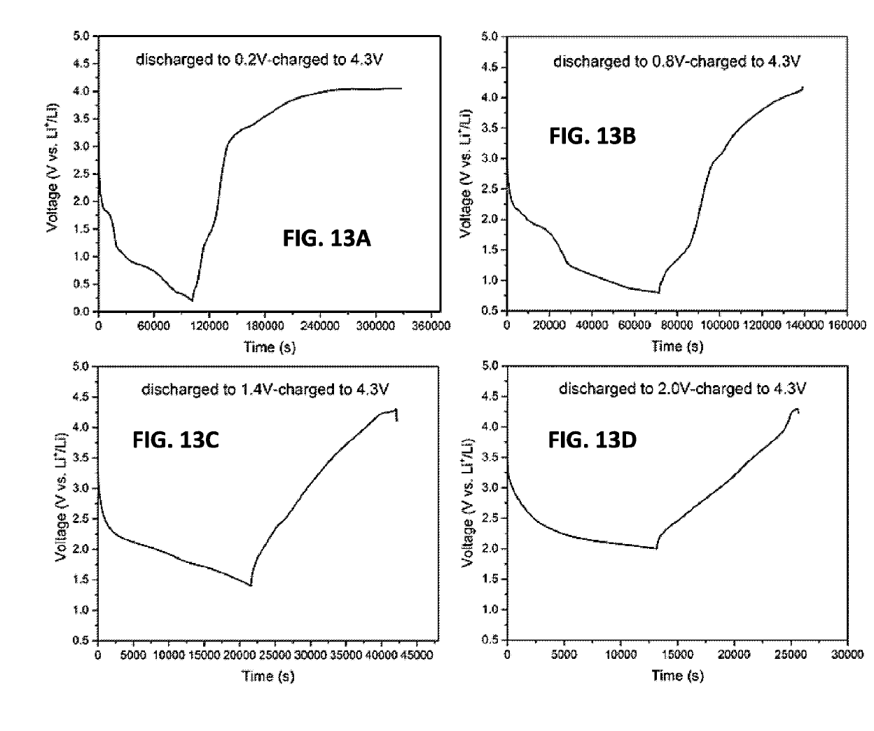

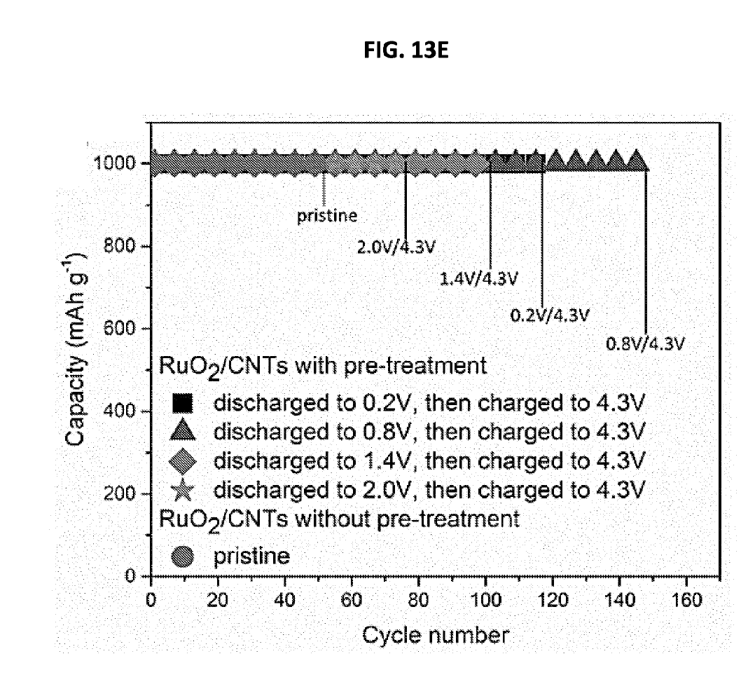

Certain embodiments of the processes disclosed herein pretreats batteries/cells with the RuO₂/CNT-based air electrodes by first discharging to 0.2 V, 0.8 V, 1.4 V and 2.0 V, respectively and then charging to 4.3 V at 0.1 mA cm⁻² with 1 M LiTf-tetraglyme electrolyte in an inert atmosphere (no oxygen, or substantially no oxygen) such as in argon gas. Voltage profiles of certain embodiments of the cells pretreated with the present processes are in FIGS. 13(a)-(d). After the disclosed two-step pretreatment process, O₂ gas was added into the Teflon container to start a Li—O₂ battery performance test, i.e. discharge and charge cycling. FIG. 13(e) shows the discharge/charge cycling performance with capacities stably retained at 1000 mAh g⁻¹, beyond that point the capacity starts to drop. As such, in certain embodiments the complete pretreatment process of first discharging to 0.8 V and then charging to 4.3 V provides superior cycling stability of the Li—O₂ battery with RuO₂/CNT-based electrode, up to at least 150 cycles.

Preparation of CNTs/PVDF/CP or RuO₂/CNTs/PVDF/CP air-electrodes comprised preparing a pre-mixed slurry containing CNTs/PVDF (4:1, weight ratio) or RuO₂/CNTs:PVDF (4:1, weight ratio) and NMP which was then cast onto a sheet of CP followed by slurry drying at 100° C. in a vacuum oven under vacuum for 24 hours. After that, this CNTs/PVDF/CP or RuO₂/CNTs/PVDF/CP electrode sheets were punched into small electrode discs with a diameter of 15.4 mm, and the CNTs loading and RuO₂/CNTs loading were 0.4 mg cm⁻² and 0.6 mg cm⁻², respectively.

Suitable carbon nanotubes (CNTs) (typical bundle length: 1˜5 μm and bundle diameter: 4˜5 nm) are available from Carbon Solutions, Inc. Ruthenium(III) chloride hydrate is purchased from Sigma-Aldrich. Carbon paper (CP) may be obtained from FuelCellStore. Lithium chips (0.25 mm thick) may be obtained from MTI Corporation. PVDF binders may be obtained from Arkema Inc. Tetraglyme, DME and LiTf may be obtained from BASF and N-methylpyrrolidone (NMP) and other chemicals may be obtained from Sigma-Aldrich.

The disclosed in-situ electrochemical pretreatment processes may be followed by regular charge/discharge battery cycling. Coin-cell-type (CR2032) Li—O₂ cells were first assembled in an argon-filled glovebox (MBraun Inc.). For each cell, a piece of separator (Whatman glass fiber B) soaked with 300 μL of 1 M LiTf-tetraglyme electrolyte was placed between an as-prepared CNTs air-electrode and a Li metal chip. Then the assembled Li∥CNTs coin cells were transferred into the Ar-filled Teflon containers. Prior to Li—O₂ battery performance measurement, these coin cells were charged at a current density of 0.1 mA cm⁻² at room temperature on an Arbin BT-2000 battery tester to 4.3 V followed by holding at 4.3 V for 0 min, 5 min, 10 min, 15 min, and 20 min, and at 4.5 V for 0 min, respectively, and firstly discharged to 0.2 V, 0.8 V, 1.4 V, and 2.0 V, then charged to 4.3 V. After the above in-situ electrochemical pretreatment, ultrahigh purity O₂ was added into these containers containing the pretreated coin cells to thoroughly purge leftover Ar gas. The Teflon containers were then filled with ultrahigh purity O₂ (at 1 atm). The Li—O₂ coin cells with in-situ pretreatment were cycled at 0.1 mA cm⁻¹ in a voltage window of 2.0 V to 4.5 V under discharge/charge capacity protocol (1000 mAh g⁻¹) on the Arbin BT-2000 battery tester. As a comparison, coin cells without in-situ pretreatment were cycled under the same conditions. The corresponding ac impedance spectra were obtained on a Solartron (SI 1287) electrochemical interface. After battery testing, the coin cells were moved back to the argon-filled glovebox and disassembled. The cycled CNT-based air-electrodes and metal anodes were washed with pure DME several times to thoroughly remove the residual electrolyte, and then vacuum dried to eliminate DME solvent.

The TEM investigation was conducted using a Titan 80-300 microscope operated at 300 kV. The microscope was equipped with an image Cs corrector for objective lens, enabling sub-angstrom resolution. SEM imaging was conducted on an FEI Helios Nanolab dual-beam focused ion beam scanning electron microscope (FIB/SEM) with an electron beam voltage of 5 kV. XPS measurements of the pre-charged electrodes were performed with a Physical Electronics Quantera scanning X-ray microprobe with a focused monochromatic AlKa X-ray (1486.7 eV) source for excitation and a spherical section analyzer. The samples were sealed on standard sample holders inside a glove box filled with argon gas prior to characterization.

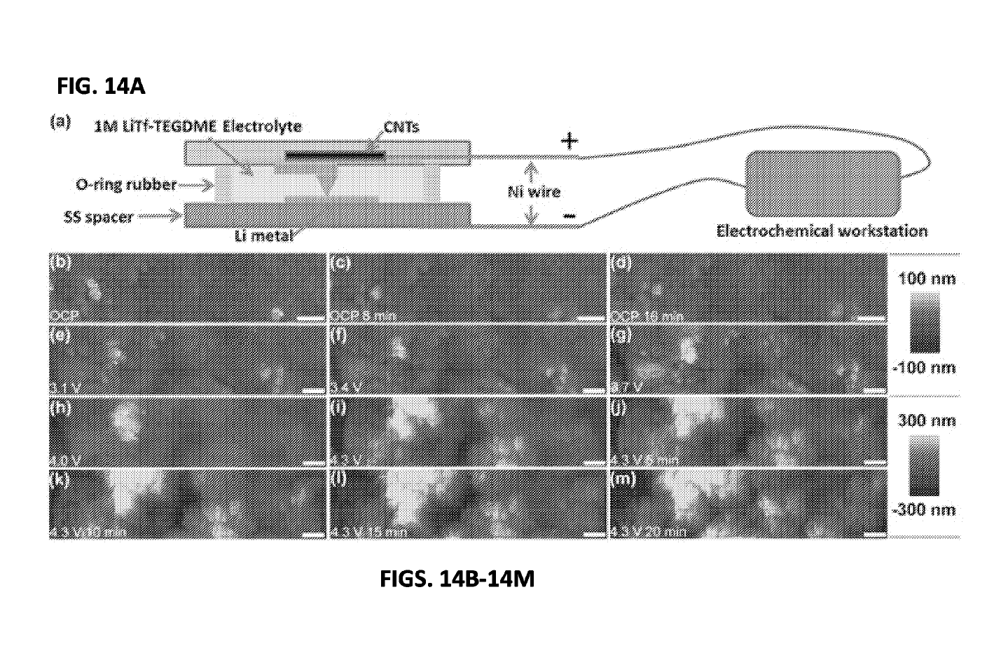

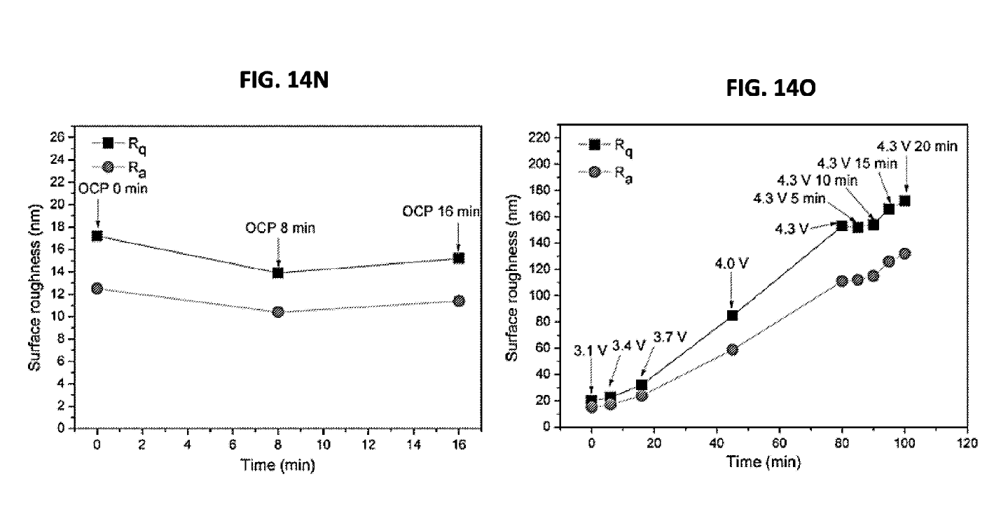

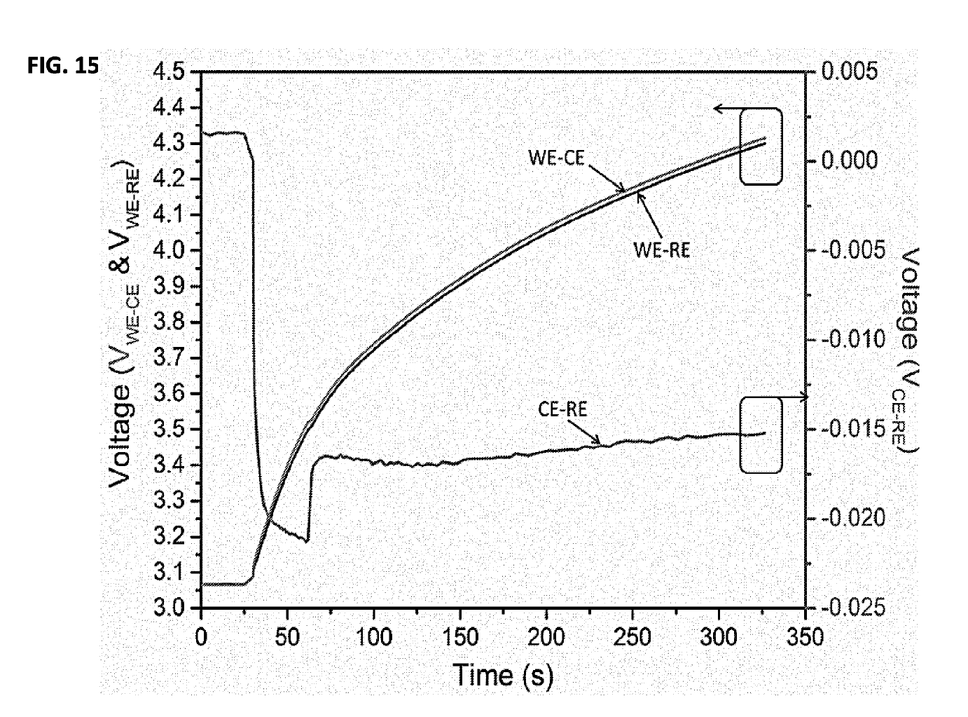

In-Situ AFM Analysis of Protective Film Formation on Li Metal Anode: The preformed SEI films on the metal anodes were further analyzed. To confirm that preformed SEI films were formed on a Li metal surface as well upon charging, an in-situ atomic force microscope (AFM) characterization was performed, as demonstrated in FIGS. 14(a)-(o). A complete setup is composed of a designed cell including CNTs/Ni wire as cathode and Li metal/SS spacer as anode integrated with AFM instrument, and an electrochemical workstation to achieve in-situ observation on formation of protective films on Li metal (FIG. 14(a)). Prior to cell charging, no obvious change of the metal surface can be found when the metal is simply in contact with electrolyte for 16 min under open circuit potential (OCP) before charging, indicating that the metal (here, Li) is very stable against this kind of ether-based electrolyte (LiTf-tetraglyme). In FIG. 14(n), the corresponding surface roughness of Li metal under OCP has been calculated on the basis of two common calculation methods (R_{q} and Rₐ, as illustrated in Formula 1 and 2 below). This shows very slight change of Li metal surface roughness due to the quickly formed ultra-thin SEI layer on the metal surface due to the reaction between Li and electrolyte, which is well consistent with the AFM images FIG. 14(b)-14(d). After that, the cell began to be gradually charged from OCP to 4.3 V (FIG. 14(e)-14(i)), which is accompanied with the growth of films on the metal. To figure out the origin of formation of the films, the carbon-based air electrode and Li anode voltage change during the pre-charging process have been investigated by using a three electrode cell on a Bio-Logic instrument, as shown in FIG. 15. From this plot, it can be seen that those films appear to originate from two main sources: 1) the electrolyte decomposition at relatively high voltage and 2) Li metal plating process that consists of Li nucleation and subsequent growth during charging. From 3.1 V to 3.7 V, the SEI film growth is relatively dull, while it becomes faster when the voltage is more than 3.7 V due to the electrolyte decomposition at a relatively higher voltage. Because it is impossible to make Li metal surface as flat as a single-atom-layer surface, slightly uneven growth of SEI films is inevitable. After charging to 4.3 V the voltage of the cell was maintained at 4.3 V for 20 min (FIG. 14(j)-14(m)). During this stage, the films not only continue to grow but also tend to be flat in micro dimension. FIG. 14(o) shows that the surface roughness of Li metal films increases more rapidly when the voltage is large than 3.7 V, and the surface roughness change of the SEI films reaches a plateau when the charging time at 4.3 V is in the range of 0 min to 10 min. Then, the film surface becomes rougher once the maintaining time increases to 15 min and then 20 min. Finally, a complete protective SEI film could be fabricated on the metal anode surface to give continuous protection for the metal anode during the battery cycling.

$$\begin{matrix}Rq = \sqrt{\frac{1}{N} {\sum }_{i = 1}^{n} {y}_{i}^{2}} & Formula 1. Calculation of surface roughness \\ Ra = \frac{1}{n} {\sum }_{i = 1}^{n} \vert {y}_{i} \vert & Formula 2. Calculation of surface roughness\end{matrix}$$

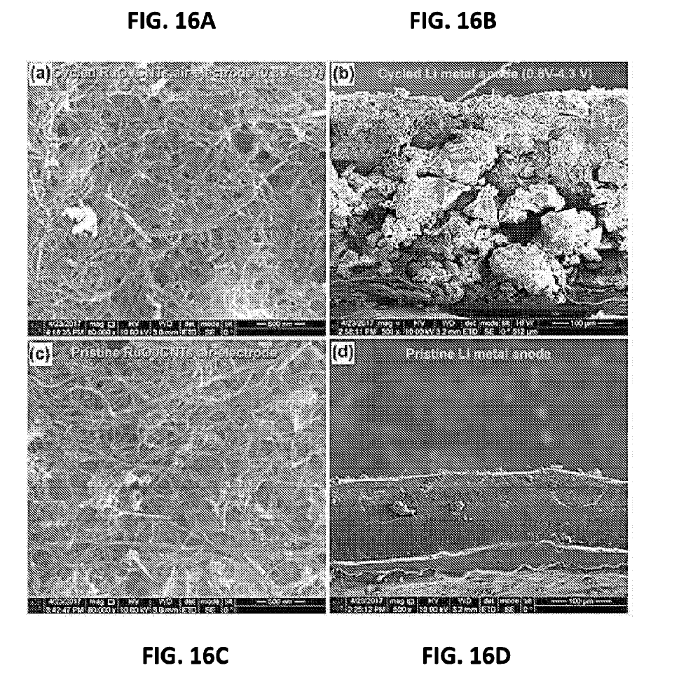

To identify the morphology change of cycled RuO₂/CNTs-based air electrodes and metal anodes, SEM images of cycled RuO₂/CNTs-based air electrodes and cycled Li metal anodes with a preferred pretreatment process (discharge to 0.8 V; then charge to 4.3 V) have been provided in FIG. 16(a) and FIG. 16(b), respectively. Although pretreated RuO₂/CNTs-based air electrodes already experienced long-term cycles, the morphology of pretreated RuO₂/CNTs-based electrodes can still be maintained (FIG. 16(a)), which is even very close to pristine (non-cycled and non-pretreated) RuO₂/CNTs-based air electrode (FIG. 16(c)). However, in FIG. 11(b), cycled Li metal anode paired with aforementioned air-electrode indicates severe degradation throughout the entire Li metal after multiple cycles when compared to the pristine compact Li metal bulk without any cycling (FIG. 16(d)). Considering the quite stable and efficient pretreated RuO₂/CNTs-based air electrode and severely corroded Li metal anode, it could be confirmed that battery performance fading is mainly due to the instability and limitation of Li metal anode, rather than the carbon-based air electrode.

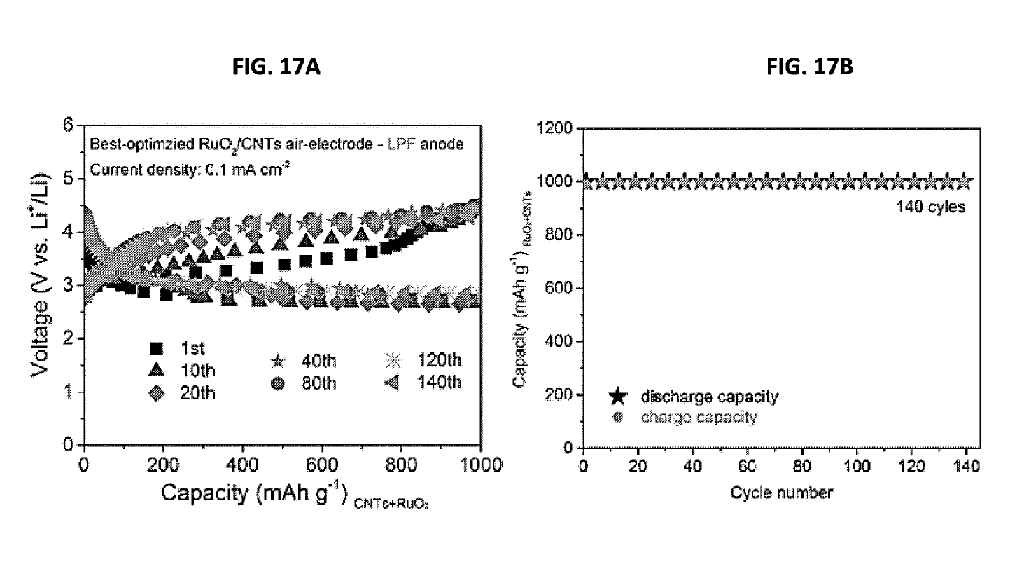

Lithium iron phosphate (LiFePO₄, LFP) has been widely used in rechargeable batteries due to low cost, environmental capability, relatively large capacity and its intrinsic stability. To demonstrate the stability of the pretreated air electrode, a metal anode (here, Li) was replaced with a LFP anode to get LFP anode and paired with above disclosed pretreated RuO₂/CNTs-based air electrode. The Li—O₂ cells delivered highly stable cycling life and significantly decreased charge/discharge over-potential, as shown in FIG. 17(a) and FIG. 17(b). These results demonstrate that the disclosed pretreatment process promote obvious enhancement in cycling stability of metal-air and metal-oxygen battery systems.

Some embodiments of the disclosed method are described below in the following numbered clauses.

1. A method for pretreating metal-air battery electrodes comprising:

exposing at least one electrode for a metal-air battery to a metal-air battery electrolyte in an inert atmosphere.

2. A method for pretreating metal-air battery electrodes comprising:

exposing a metal-air battery cathode and a lithium, sodium, potassium, magnesium, aluminum, iron, or zinc anode, simultaneously, to a metal-air battery electrolyte in an inert atmosphere.

3. A method for pretreating metal-air battery electrodes comprising:

exposing a carbon-based cathode and a lithium metal anode to a lithium-air battery electrolyte in an inert atmosphere.

4. A method for pretreating metal-air battery electrodes comprising:

exposing a carbon-based material or carbon-based material/catalyst composite cathode and a lithium (or sodium, potassium) metal anode simultaneously to a metal-air battery electrolyte in an inert atmosphere.

5. A method for pretreating metal-air battery electrodes comprising:

exposing a carbon nanotubes (CNTs)-material or CNTs-material/RuO₂ composite cathode and a lithium, sodium, or potassium metal anode simultaneously to a metal-air battery electrolyte in an inert atmosphere.

6. The method of any of the preceding clauses wherein the inert atmosphere is argon, nitrogen, helium, or neon gas.

7. The method of any of the preceding clauses wherein the at least one electrode for a metal-air battery is a carbon based cathode or a carbon material or catalyst composite cathode.

8. The method of any of the preceding clauses wherein the at least one electrode for a metal-air battery is formed of (i) carbon fibers, graphene, carbon nanotubes, graphite or any mixture thereof, or (ii) carbon fibers, graphene, carbon nanotubes, graphite, or any mixture thereof in combination with a functional catalyst selected from RuO₂, Pt, Ru, Au, Pd, Ir, IrO₂, MnCo₂O₄, ZnCo₂O₄, or any mixture thereof.

9. The method of any of the preceding clauses wherein the at least one electrode for a metal-air battery is a lithium, sodium or potassium metal anode.

10. The method of any of the preceding clauses wherein the at least one electrode for a metal-air battery is charged with an areal current density from 0.01 mA cm⁻² to 5 mA cm⁻².

11. The method of any of the preceding clauses wherein the at least one electrode for a metal-air battery is charged with an areal current density from 0.05 mA cm⁻² to 2 mA cm⁻².

12. The method of any of the preceding clauses wherein the at least one electrode for a metal-air battery is charged with an areal current density from 0.1 mA cm⁻² to 0.5 mA cm⁻².

13. The method of any of the preceding clauses wherein the at least one electrode for a metal-air battery is charged to 5 V.

14. The method of any of the preceding clauses wherein the at least one electrode for a metal-air battery is charged at 4.3 V.

15. The method of any of the preceding clauses wherein the at least one electrode for a metal-air battery is charged for a time period of from 1 second to 1 hour.

16. The method of any of the preceding clauses wherein the at least one electrode for a metal-air battery is charged for a time period of from 30 seconds to 30 minutes.

17. The method of any of the preceding clauses wherein the at least one electrode for a metal-air battery is charged for a time period of from 1 minutes to 15 minutes.

18. The method of any of the preceding clauses wherein the at least one electrode for a metal-air battery is charged for 10 minutes.

19. The method of any of the preceding clauses wherein the electrolyte is lithium trifluoromethanesulfanate, or sodium trifluoromethanesulfanate, or potassium trifluoromethanesulfanate.

20. A method for pretreating metal-air battery electrodes comprising:

exposing a CNTs-material cathode and a lithium, sodium, or potassium metal anode to a metal-air battery electrolyte in an atmosphere with less than 1 wt % of oxygen; and

applying a constant voltage of 4.3 V to the CNTs-material cathode and the lithium, sodium, or potassium metal anode, simultaneously, for a time period of 10 minutes, while the cathode and anode are in the atmosphere with less than 1 wt % of oxygen.

1. A method for pretreating metal-air battery electrodes comprising:
exposing at least one electrode for a metal-air battery to a metal-air battery electrolyte in an inert atmosphere.

2. The method of claim 1, wherein the exposing at least one electrode further comprises exposing a metal-air battery cathode and a lithium, sodium, potassium, magnesium, aluminum, iron, or zinc anode, simultaneously, to a metal-air battery electrolyte in an inert atmosphere.

3. The method of claim 1, wherein the exposing at least one electrode further comprises exposing a carbon-based cathode and a lithium metal anode to a lithium-air battery electrolyte in an inert atmosphere.

4. The method of claim 1, wherein the exposing at least one electrode further comprises exposing a carbon-based material/catalyst composite cathode and a lithium (or sodium, potassium) metal anode simultaneously to a metal-air battery electrolyte in an inert atmosphere.

5. A method for pretreating metal-air battery electrodes comprising:
exposing a carbon nanotubes (CNTs)-material or CNTs-material/RuO₂ composite cathode and a lithium, sodium, or potassium metal anode simultaneously to a metal-air battery electrolyte in an inert atmosphere.

6. The method of claim 1 wherein the at least one electrode for a metal-air battery is a carbon based cathode or a carbon material or catalyst composite cathode.

7. The method of claim 1 wherein the at least one electrode for a metal-air battery is formed of (i) carbon fibers, graphene, carbon nanotubes, graphite or any mixture thereof, or (ii) carbon fibers, graphene, carbon nanotubes, graphite, or any mixture thereof in combination with a functional catalyst selected from RuO₂, Pt, Ru, Au, Pd, Ir, IrO₂, MnCo₂O₄, ZnCo₂O₄, or any mixture thereof.

8. The method of claim 1 wherein the at least one electrode for a metal-air battery is a lithium, sodium or potassium metal anode.

9. The method of claim 1 wherein the at least one electrode for a metal-air battery is charged with an areal current density from 0.01 mA cm⁻² to 5 mA cm⁻².

10. The method of claim 1 wherein the at least one electrode for a metal-air battery is charged with an areal current density from 0.05 mA cm⁻² to 2 mA cm⁻².

11. The method of claim 1 wherein the at least one electrode for a metal-air battery is charged with an areal current density from 0.1 mA cm⁻² to 0.5 mA cm⁻².

12. The method of claim 1 wherein the at least one electrode for a metal-air battery is charged to 5 V.

13. The method of claim 1 wherein the at least one electrode for a metal-air battery is charged at 4.3 V.

14. The method of claim 1 wherein the at least one electrode for a metal-air battery is charged for a time period of from 1 second to 1 hour.

15. The method of claim 1 wherein the at least one electrode for a metal-air battery is charged for a time period of from 30 seconds to 30 minutes.

16. The method of claim 1 wherein the at least one electrode for a metal-air battery is charged for a time period of from 1 minutes to 15 minutes.

17. The method of claim 1 wherein the at least one electrode for a metal-air battery is charged for 10 minutes.

18. The method of claim 1 wherein the inert atmosphere is argon, nitrogen, helium, or neon gas.

19. The method of claim 1 wherein the electrolyte is lithium trifluoromethanesulfanate, or sodium trifluoromethanesulfanate, or potassium trifluoromethanesulfanate.

20. A method for pretreating metal-air battery electrodes comprising:
exposing a CNTs-material cathode and a lithium, sodium, or potassium metal anode to a metal-air battery electrolyte in an atmosphere with less than 1 wt % of oxygen; and
applying a constant voltage of 4.3 V to the CNTs-material cathode and the lithium, sodium, or potassium metal anode, simultaneously, for a time period of 10 minutes, while the cathode and anode are in the atmosphere with less than 1 wt % of oxygen.
